(19) United States
(12) Patent Application Publication
(10) Pub. No.: US 2026/0298640 A1
(43) Pub. Date: Oct. 1, 2026

(54) MAP MATCHING ON LOW SAMPLING RATE TRAJECTORIES THROUGH DEEP INVERSE REINFORCEMENT LEARNING AND MULTI-INTENTION MODELING

(71) Applicant: UTI Limited Partnership, Calgary (CA)

(72) Inventors: Reza SAFARZADEH, Calgary (CA); Xin WANG, Calgary (CA)

(21) Appl. No.: 19/573,033

(22) Filed: Mar. 20, 2026

Related U.S. Application Data
(60) Provisional application No. 63/775,045, filed on Mar. 20, 2025.

(30) Foreign Application Priority Data
Aug. 15, 2025 (CA) 3283086

(51) Int. Cl. G01C 21/30; G06N 3/092

(52) U.S. Cl. CPC G01C 21/30; G06N 3/092

(57) ABSTRACT

Systems and methods of map matching are provided that can model driving behavior by learning reward functions that characterize the driving preferences of different driver groups from historical trajectory data using multi-intention deep inverse reinforcement learning, or features thereof. MIDIRL can use historical trajectory data to infer the underlying reward functions, which may reflect different driving behavior. An IRL model may be used to observe the known driving trajectories and learn the reward structures that would have led to the known driving paths. MIDIRL can integrate IRL into the map matching process and may use a Q-learning algorithm to search for the best-connected path between consecutive GPS points received as new location data. The algorithm can maximize the cumulative reward by considering both the reward values and the travel time differences and determine the driving path on a road network between at least two location data points.

### FIELD

The present disclosure relates generally to systems and methods for map matching.

### BACKGROUND

Analyzing freight vehicle movements using GPS trajectory data can present challenges due to environmental conditions and hard-ware limitations impacting data accuracy. Map matching, the process of aligning GPS signals with road networks, facilitates accurate route reconstruction. However, existing methods have limitations, particularly with low and ultra-low sampling rates. They often assume the shortest path between points, overlook historical data insights, and neglect diverse driving behaviors, which may not align with real-world scenarios where shortest paths are not always optimal and different drivers exhibit varied behaviors. These limitations affect existing current methods' reliability, especially when using low sampling rate trajectories.

Accordingly, improved systems and methods for map matching are desired.

### SUMMARY

The present disclosure describes a method of map matching, the method comprising: I. obtaining location data of a vehicle on a road network; II. using a classifier to classify the location data to a cluster for generating classified location data; and III. determining a driving path of the vehicle on the road network based on the classified location data by: determining possible driving paths on the road network between at least two data points of the location data, and applying a policy of the cluster to select the driving path from the possible driving paths; wherein: the classifier is a trained machine learning model that is trained on known driving data labelled with cluster labels of clusters; the known driving data comprises known location data and known road segment features; each of the clusters comprises a set of the known driving data and a reward function that are determined by: training policies for the clusters using an inverse reinforcement learning (IRL) model, wherein the IRL model comprises: the known road segment features as inputs to the reward function for each of the clusters, and known driving paths corresponding to the known driving location as expert behavior; and the clusters and each set of the known driving data corresponding to the clusters are labelled with the cluster labels.

In a further embodiment, the trained machine learning model is a deep neural network.

In a further embodiment, training policies for the clusters further comprises using expectation-maximization clustering to form the clusters of the known driving data based on road segment features.

In a further embodiment, the road segment features comprise one or more of speed limit, speed range, speed category road type, lane count, traffic light status, traffic light presence, or turn type.

In a further embodiment, the inverse reinforcement learning model comprises a deep inverse reinforcement learning model.

In a further embodiment, applying a policy of the cluster to select the driving path from the possible driving paths further comprises matching the driving path to a travel time.

In a further embodiment, determining possible driving paths of the road network further comprises determining possible road segments at each node of the road network, and applying a policy of the cluster to select the driving path from the possible driving paths further comprises applying the policy to select a road segment from the possible road segments.

In a further embodiment, a Q-learning algorithm is used to determine possible driving paths on the road network.

In a further embodiment, each of the clusters represents a driving behavior.

In a further embodiment, the driving behavior comprises one or more of a road type preference, toll avoidance, cargo handling, or optimized travel time.

In a further embodiment, a total number of clusters is predefined.

In a further embodiment, the location data is received at a sampling rate above 2 minutes.

According to another aspect of the disclosure, a method is provided for training a multi-intention inverse reinforcement learning model comprising: obtaining driving data and known driving paths of a plurality of vehicles on a road network, the driving data comprising known location data and known road segment features; applying an expectation-maximization model to categorize two or more sets of the driving data to two or more clusters, respectively; and training policies for each of the two or more clusters using an inverse reinforcement learning (IRL) model, wherein the IRL model comprises: the known road segment features as inputs to the reward function for each of the clusters, and the known driving paths corresponding to the driving as expert behavior.

In a further embodiment, the clusters and each set of the driving data corresponding to the two or more clusters are labelled with cluster labels.

In a further embodiment, the IRL model comprises a deep IRL model.

In a further embodiment, each of the two or more clusters represents a driving behavior.

In a further embodiment, the driving behavior comprises one or more of a road type preference, toll avoidance, cargo handling, or optimized travel time.

In a further embodiment, the road segment features comprise one or more of speed limit, speed range, speed category road type, lane count, traffic light status, traffic light presence, or turn type.

In a further embodiment, a total number of clusters is predefined.

According to another aspect of the disclosure, a non-transitory computer-readable medium storing instructions is provided which, when executed, cause one or more processors to perform operations comprising: I. obtaining location data of a vehicle on a road network; II. using a classifier to classify the location data to a cluster for generating classified location data; and III. determining a driving path of the vehicle on the road network based on the classified location data by: determining possible driving paths on the road network between at least two data points of the location data, and applying a policy of the cluster to select the driving path from the possible driving paths; wherein: the classifier is a trained machine learning model that is trained on known driving data labelled with cluster labels of clusters; the known driving data comprises known location data and known road segment features; each of the clusters comprises a set of the known driving data and a reward function that are determined by: training policies for the clusters using an inverse reinforcement learning (IRL) model, wherein the IRL model comprises: the known road segment features as inputs to the reward function for each of the clusters, and known driving paths corresponding to the known driving location as expert behavior; and the clusters and each set of the known driving data corresponding to the clusters are labelled with the cluster labels.

### BRIEF DESCRIPTION OF THE FIGURES

Embodiments of the present disclosure will now be described, by way of example only, with reference to the attached Figures.

FIGS. 1A and 1B show an example of map matching. FIG. 1A shows a raw truck GPS trajectory (before map matching), and FIG. 1B shows the actual travelled path (after map matching).

FIG. 2A shows example limitations of HMM-based map matching algorithms on low-frequency rates GPS trajectories.

FIG. 2B shows example multiple driving behavior intentions.

FIG. 3 shows (a) Actions on the road network: edges are the states, actions are available transitions. (b) Actions and rewards: actions (a₁, a₁, a₁) from state sₜ with associated rewards, using a grayscale gradient to indicate values.

FIG. 4 shows an overview of multi-intention deep inverse reinforcement learning (MIDIRL).

FIG. 5 shows a training process in Single Intention Deep MaxEntIRL to capture truck driver route choice behavior for each driver intention group.

FIGS. 6A and 6B show the sampling rate distribution for (a) Calgary and (b) Edmonton.

FIGS. 7A and 7B show road network study areas for (a) Calgary and (b) Edmonton.

FIGS. 8A and 8B show a performance comparison of route mismatch fraction (RMF) for (a) Calgary and (b) Edmonton.

FIGS. 9A and 9B show a performance comparison of running time for (a) Calgary and (b) Edmonton.

FIGS. 10A and 10B show a performance comparison based on number of intentions: (a) effect of number of intentions on model RMF and (b) effect of number of intentions on average matching time.

FIG. 11 shows matching accuracy under different training size and sampling rate.

FIG. 12 shows visualization of trajectory density in the City of Calgary dataset.

FIG. 13 shows matching accuracy under different trajectory density.

FIG. 14 shows sample driving behavior patterns learned from the city of Calgary data.

FIG. 15 shows a comparison of matched paths of a sampling interval of five minutes: (a) HMM; (b) ST-Matching; (c) CMM; (d) L2MM; (e) MIDIRL.

FIG. 16 shows a comparison of matched paths of a sampling interval of 10 minutes: (a) HMM; (b) ST-Matching; (c) CMM; (d) L2MM; (e) MIDIRL.

FIG. 17 shows sample cases demonstrating some inaccuracies in the MIDIRL map matching.

### DETAILED DESCRIPTION

Generally, the present disclosure provides multi-intention deep inverse reinforcement learning (MIDIRL) for map matching. MIDIRL integrates deep neural networks and multi-intention capturing mechanisms with inverse reinforcement learning to model complex driving preferences from historical trajectories, which can improve map matching accuracy, especially in ultra-low-frequency trajectories. Examples provided in the present disclosure describe experiment on real-world datasets that demonstrate MIDIRL's improved accuracy and/or efficiency of map matching compared to previous methods, and show improvements on prior methods using limited or less training data.

While the present disclosure uses examples of truck drivers and matching trajectories driven on road networks, the present disclosure may be applied to other contexts and applications, and the examples are not intended to be limiting. For example, the map matching may be used for other vehicle types, such as cars, aerial vehicles, autonomous vehicles, etc. The map matching may refer to any other applications related to mapping data points on a directed graph or other network.

### 1. Introduction

With the advent of GPS devices, tracking freight vehicles and analyzing their movements has become possible. However, analyzing GPS trajectory data can have challenges. One challenge is the sparsity of low-frequency trajectory data, which results from less frequent recording of GPS points from a driver. This sparsity can cause discrepancies between the recorded trajectory points and the actual road network. Factors like tall buildings in urban areas, mountainous terrain, the quality of the installed GPS device, and severe weather conditions can reduce the quality of GPS signals. Despite these challenges, low-frequency trajectory data are preferred in some contexts because it reduces data transmission requirements. For a large number of moving objects, transmitting high-frequency GPS data would require substantial bandwidth and storage capacity, leading to increased costs and complexity in data management. To reduce the costs associated with data transmission in large-scale trajectory data, limited location data (such as the coordinate location of the vehicle) are generally collected at lower sampling rates (Chen et al. 2014). Reducing the frequency of GPS recordings can minimize data transmission and storage needs while still obtaining useful information for tracking and analyzing vehicle movements.

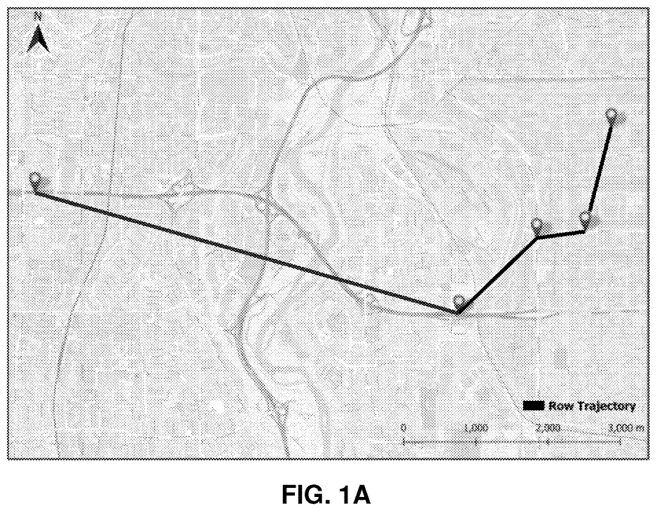

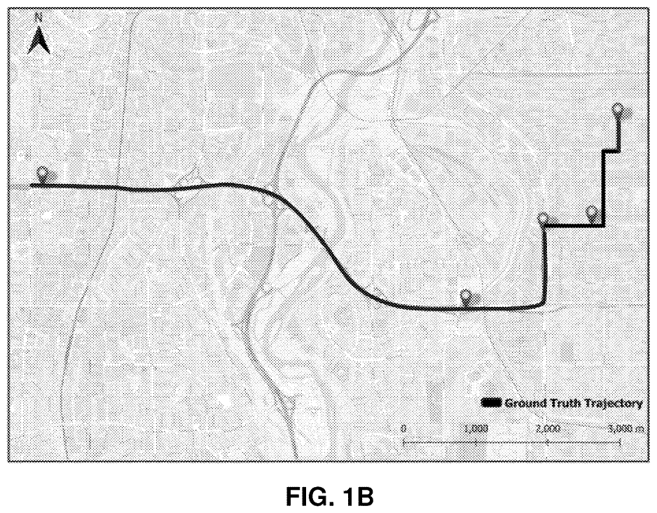

Map matching is the technique that refers to the procedure of accurately aligning GPS signals with the specific routes taken by vehicles, allowing reconstruction of their actual routes and being able to analyze their movements. FIG. 1A displays an instance of a freight vehicle raw GPS trajectory that connects each GPS point with a straight line, and FIG. 1B shows the map-matched trajectory, displaying the vehicle's true path on the road network.

Different methods have been suggested to enhance the map matching efficiency among which, hidden Markov model (HMM)-based algorithms such as HMM map matching, and Spatial Temporal (ST-Matching) along with their extensions are sometimes used due to their capability to model sequential activity and road network connectivity (Lou et al. 2009, Newson and Krumm 2009). However, these methods can have limitations, including when applied to GPS trajectories with low sampling rates (beyond 30 s) and ultra-low sampling rates (exceeding 2 min) (Huang et al. 2021).

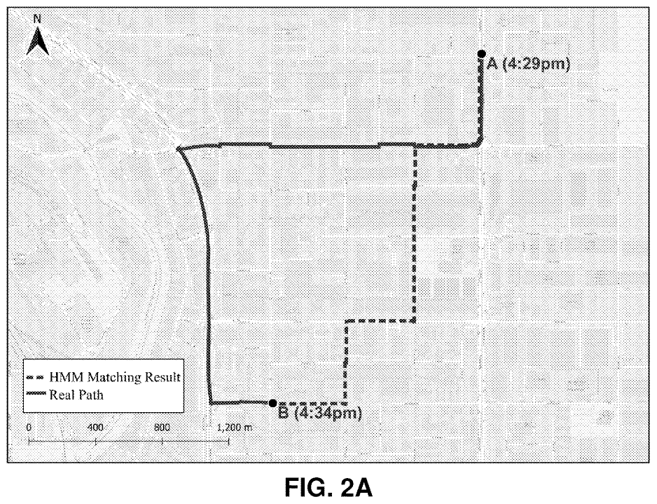

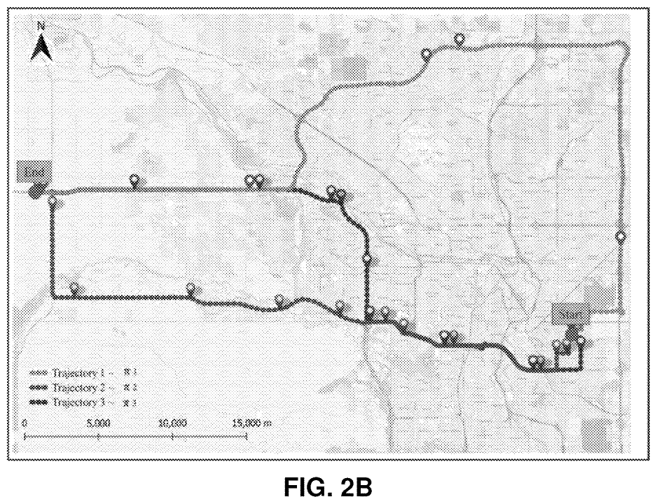

First, one of the issues with these algorithms is their assumption of the shortest path between consecutive points (Yuan et al. 2010). However, in reality, drivers may not always select the shortest path. Various factors such as cargo handling, toll fees, time restrictions and driver preferences can influence the route selection process. FIG. 2A shows an example of map matched driving path of a truck driver in comparison to the actual driving path taken. As shown in FIG. 2A, the actual route taken by the truck driver (solid line) differs from the path generated by the HMM algorithm (dashed line), as the driver chooses highways over the shortest distance. The reliance on the shortest path can lead to inaccuracies in matching outcomes, particularly in GPS trajectories with low and ultra-low sampling rates in which the number of possible matching road segments between the two GPS points significantly increases.

The second limitation is that many existing algorithms often perform map matching on an individual trajectory in isolation, overlooking the potential insights from historical trajectory data regarding travel duration, frequency and drivers' preferences. For instance, some studies have shown that truck drivers frequently prefer familiar routes and exhibit consistent stopping behaviors, which can be valuable for predicting their future choices (Shin et al. 2019). Thus, efficiently leveraging historical data from the same drivers and/or other truck drivers on similar routes can help better understand truck movement dynamics, which may improve map matching efficiency.

The third challenge in current models is that while some existing models, such as those disclosed in Huang et al. (2018), Bian et al. (2020), Feng et al. (2020), use past trajectories to suggest map matching, these models mainly focus on learning the most common patterns from historical data representing trends or average route choices of the entire group of drivers in the data set. These models miss out on capturing individual driver behavior and decision-making factors. To model truck drivers' driving behavior, one potential approach is inverse reinforcement learning (IRL), which has been applied in various driving behavior modeling tasks (Ziebart et al. 2008, Ondruska and Posner 2014, Zhao and Liang 2022, 2023). However, a limitation of these studies is the absence of recognizing that historical data are sourced from a plurality of drivers, in which the drivers may exhibit different or diverse driving behaviors. By focusing solely on modeling a single driving behavior, existing approaches risk inaccuracies and cannot fully capture the variability present in real-world driving scenarios. In many real situations, different drivers opt for different routes between the same starting and ending points. As an example, FIG. 2B demonstrates different behaviors among truck drivers traveling at the same start and end points, possibly influenced by factors like road conditions, traffic, tolls or familiarity. Hence, when building a model based on historical data, incorporating the drivers' route choice preferences and accounting for the learning of multiple driving intentions from the historical trajectories can improve the model.

To address the challenges outlined above, the present disclosure provides systems and methods for map matching using multi-intention deep inverse reinforcement learning (MIDIRL). MIDIRL integrates deep neural networks (DNNs) and employs a multi-intention capturing mechanism to model complex multiple driving preferences derived from historical trajectory data. MIDIRL aims to achieve improved map matching, and may improve map matching in scenarios with low or ultra-low-frequency trajectories.

First, MIDIRL may model driving behavior by learning reward functions that characterize the driving preferences of different driver groups from historical trajectory data. Historical trajectories can be sequences of GPS points that represent the paths taken by drivers. MIDIRL can use these sequences to infer the underlying reward functions, which reflect the route choice preferences and/or tendencies (i.e., the driving behavior(s)) of specific driver groups that take actions in given states. This can be achieved by using IRL, where the model observes the known trajectories and learns the reward structures that would have led to those paths.

Second, the learned reward functions can be used to evaluate the cost of potential paths during the map matching process. For each pair of consecutive GPS points in a new trajectory, MIDIRL considers all candidate road segments (i.e., possible paths) and uses the reward functions to find the most likely path that aligns with the driving preferences of the identified group.

Third, MIDIRL can integrate IRL into the map matching process by employing a Q-learning algorithm to search for the best-connected path between consecutive GPS points. The algorithm can maximize the cumulative reward by considering both the reward values and the travel time differences, such that the selected path incorporates both route choice preferences and travel efficiency in terms of travel time.

By generating synthetic data that emulates real routes taken by truck drivers between GPS points, MIDIRL can provide map matching with low or ultra-low-frequency GPS data. The present disclosure provides:
(1) a multi-intention deep IRL-based framework called MIDIRL that can learn the truck driving behavior by observing historical trajectories and use the learned preferences to perform map matching by finding actual routes taken by drivers on low or ultra-low sampling rates in truck GPS signals.
(2) MIDIRL can integrate a DNN into the MaxEnt IRL framework, which may improve the model's ability to capture more complex representations of driving behaviors and non-line-arities in the decision-making process of truck drivers when choosing routes.
(3) MIDIRL can employ a multi-intention capturing mechanism through expectation maximization (EM) clustering that may allow for improved capturing of diverse driving behaviors and route choice preferences, for example when historical observations involve unlabeled multiple intentions.
(4) As discussed in the examples of the present disclosure, experiments on two real case studies were performed with truck GPS trajectory datasets to validate the algorithm's performance in comparison to baseline methods. MIDIRL demonstrated improvements, including in scenarios with limited training data.

### 2. Prior Methods of Map Matching

This section provides an overview of existing map matching methods for trajectories with low sampling rates and IRL approaches for modeling driving behaviors.

### 2.1 Map Matching

Newson and Krumm (2009) introduced a map matching algorithm using hidden Markov models (HMMs) for low-frequency trajectories. Some subsequent studies provide potential improvements to HMM map matching algorithm to address some of its limitations (Jagadeesh and Srikanthan 2017, Yang and Gidofalvi 2018, Chen et al. 2020, Qi et al. 2024). Despite these improvements, computational challenges persist, and the models remain sensitive to noise and frequency, especially when time gaps exceed 60 seconds.

Moreover, there are probabilistic methods, like the ST-Matching algorithm by Lou et al. (2009), which incorporates spatial and temporal features and considers the road network's speed limit to improve map matching accuracy. Another approach, the interactive voting-based map matching (IVMM) provided by Yuan et al. (2010), takes into account contextual GPS points and uses an interactive voting process based on the ST-Matching algorithm, improving accuracy compared to the original ST-Matching. However, a common limitation among these map matching algorithms is their sensitivity to noise and sparseness, leading to difficulties in generating a complete connected path, especially when dealing with low or ultra-sparse GPS data. For example, with five-minute time gaps at highway speeds (e.g., 60 mph), multiple network links may be traversed between GPS points, which can cause gaps in constructing the full vehicle path.

Alternate techniques can use historical high sampling rate GPS trajectories as the complementary source to help improve the accuracy of map matching in such low or ultra-low sampling rate cases. One such method, the history-based route inference system (HRIS) by Zheng et al. (2012), uses high-frequency trajectory data to identify historical routes. HRIS connects local routes based on popularity and confidence, culminating in a globally scored route using dynamic programming. Another approach by Huang et al. (2018) uses frequent patterns from high-frequency trajectories to estimate the most probable path for low-sampling-rate GPS data. Bian et al. (2020) also proposed a collaborative map matching method that involves batch processing of GPS trajectories by clustering and collaborative mapping onto the road network after data resampling. A drawback of these models is that they focus primarily on estimating the likelihood of a candidate route based on historical GPS data and ignore the pattern of route choice from the standpoint of the driver. As discussed in relation to the systems and methods of the present disclosure, incorporating driving behavior through modeling driver route selection preferences can improve GPS trajectory map matching, including when dealing with low-sampling rate GPS trajectories.

Another approach involves incorporating driver-specific preference analysis as a complement to map matching. For example, Osogami and Raymond (2013) utilized maximum entropy IRL (MaxEnt IRL), integrating turn type and travel distance into HMM transition probabilities, resulting in a more natural driving style. Yin et al. (2018) considered GPS observations and human factors to calculate route traversal costs, while Shen et al. (2020) integrated major road preferences into their encoder-decoder map matching model, improving efficiency. DeepMM proposed by Feng et al. (2020) used a deep learning sequence-to-sequence (seq2seq) based model to leverage embedded mobility patterns in training trajecto-ries, and L2MM by Jiang et al. (2022) refined DeepMM by integrating high-frequency trajectories and common mobility patterns, yet L2MM lacks consideration for road net-work connectivity and topology due to its grid-based transformation.

Thus, current methods of map matching can have reduced performance when the driving data comprises low or ultra-low-frequency trajectories. Specifically, existing models do not account for the spatial topology and connectivity of the road network, resulting in sparse outcomes that do not follow the road topology in ultra-low sampling cases. Additionally, while these models use historical data, they do not incorporate or reflect the different driving behaviors present in the historical data. Historical trajectories can originate from diverse drivers with varying behaviors and preferences. Therefore, considering multiple driving behaviors when extracting insights from historical data can improve a model's performance. The systems and methods of the present disclosure that use features of MIDIRL provide an improvement to existing methods in at least two ways: first, by using deep IRL to model the road network as the environment, which can account for road network topology and spatial connectivity; and/or second, by employing a deep multiple intention mechanism to distinguish different hidden driving patterns in historical trajectories. Thus, MIDIRL can provide improved map matching results that are more accurate and/or more efficient, including in low or ultra-low sampling cases.

### 2.2 Route Choice Modeling via IRL

According to the present disclosure, IRL may be used to capture the behaviors and route preferences of truck drivers, which may improve map matching accuracy.

Ziebart et al. (2008) utilized MaxEnt IRL to mimic taxi driver behavior, successfully generating synthetic but realistic trajectories similar to real taxi trajectories. Similarly, Ondruska and Posner (2014) forecasted electric vehicle personal routes using MaxEnt IRL and considering driver preference modeling. However, a limitation of these models is related to simplifying reward functions in MaxEnt IRL.

IRL can also be used in route planning and recommendation using historical data. For instance, Wulfmeier et al. (2017) applied deep MaxEnt IRL for large-scale driver path planning. Pflueger et al. also utilized deep maximum entropy in planetary rover missions (Pflueger et al. 2019). Liu et al. combined maximum entropy deep IRL with Dijkstra's algorithm for improving the route planning for food delivery (Liu et al. 2020). Moreover, Liu and Jiang developed a personalized route recommendation system for ride-hailing services (Liu and Jiang 2022), while Barnes et al. (2023) extended deep MaxEnt IRL for a global route finding system.

A limitation of these approaches is that they are developed to infer a single reward function from past trajectories. However, in practice, historical datasets often originate from various sources and involve different drivers with diverse behaviors. Some scholars have employed EM (Babes et al. 2011) and non-parametric methods (Choi and Kim 2012). Babes et al. (2011) used EM-based clustering to learn reward functions for each cluster, while Choi and Kim (2012) employed Bayesian IRL with a mixture model for trajectory clustering accommodating diverse intentions. Other studies, such as Gleave and Habryka (2018), Bighashdel et al. (2021) and Snoswell et al. (2021), further explored IRL with multiple intentions, employing methods like Dirichlet processes, EM, entropy optimization and feature space clustering for various applications.

Considering the characteristics of truck drivers' preferences, the present disclosure combines the feature-based driving behavior of the trucks with IRL and focus on the truck GPS trajectories map matching. The systems and methods described of the present disclosure that use MIDIRL or features of MIDIRL provides at least the following two improvements over the existing works described above: (1) unlike earlier studies that overlook truck drivers' driving behaviors, MIDIRL can identify and represent various truck driving behavior preferences; and/or (2) while prior studies do not directly utilize driver behavior patterns to increase map matching efficiency and/or accuracy, MIDIRL can use these driving behavior patterns as guide to improve the accuracy of truck trajectory map matching.

### 3. Methodology

### 3.1 Definitions

Definition 1. (GPS point) A GPS signal, which may be represented as p=(l,t,u), can identify a specific location (I), the corresponding times (t), and/or other attributes (u) such as speed or direction.

Definition 2. (Road network graph) A road network graph may be denoted as G=(V, E), where V comprises the nodes, which may be expressed as V={v₁,v₂, . . . , v_{|v|}}; E⊆V×V may represent the directed edges, and may be expressed as E={e₁, e₂, . . . , e_{|E|}}. Nodes may correspond to intersections along the roads and may be denoted as v=(v_{id}, vₗₐₜ, vₗₒₙ), where v_{id} may represent the identification of the node, and vₗₐₜ and vₗₒₙ may represent the geographical coordinates (latitude and longitude) of the node's location. Edges may represent road segments and may be denoted as e=(vₛₜₐᵣₜ, v_{end}, κ), where vₛₜₐᵣₜ may represent the starting node of the segment, v_{end} may represent the ending node of the segment, and eᵤ may represent the attributes of the segment, such as speed, type, length, etc. Both directions of a road segment, vₛₜₐᵣₜ→v_{end} and v_{end}→vₛₜₐᵣₜ, may be considered separate edges in the road network graph, which may allow for a representation of the connectivity and topology of the road network with improved accuracy.

Definition 3. (GPS trajectory) A GPS trajectory may be defined as a set of GPS points arranged in chronological order based on time. ζ={p₁,p₂, . . . , pᵢ} may represent a GPS trajectory, where pᵢ denotes a GPS point.

Definition 4. (Driving path) A driving path may be identified as a set of connected edges in the road network graph, and may be denoted as Dr={e₁, e₂, . . . , e_{|Dr|}}. Each road segment, denoted as eᵢ, may be physically linked to the subsequent segment eᵢ₊₁ through a shared node in the graph. The driving path captures the real movement of the truck along the road network corresponding to the GPS trajectories.

### 3.2 IRL Environment Definitions for Route Choice Modelling

Driver route selection may involve a step-by-step decision-making process, with drivers choosing actions at each intersection to progress to the next road segment. This process can be represented as a Markov decision process (MDP). Each MDP may comprise M={S, A, T, R, γ}. In the proposed configuration, each parameter may be defined as follows:

State: The state sₜ at time t represents the current road segment (edge) the truck is on. Formally, sₜ may be defined by the (vₛₜₐᵣₜ, v_{end}, κ) where vₛₜₐᵣₜ may be the node ID of the starting intersection, and v_{end} is the node ID of the ending intersection of the road segment.

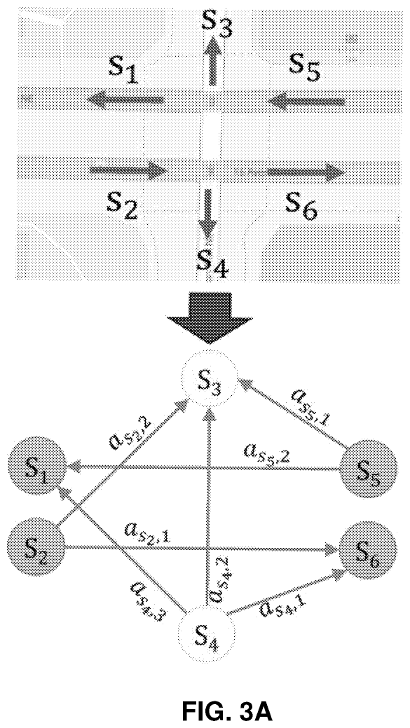

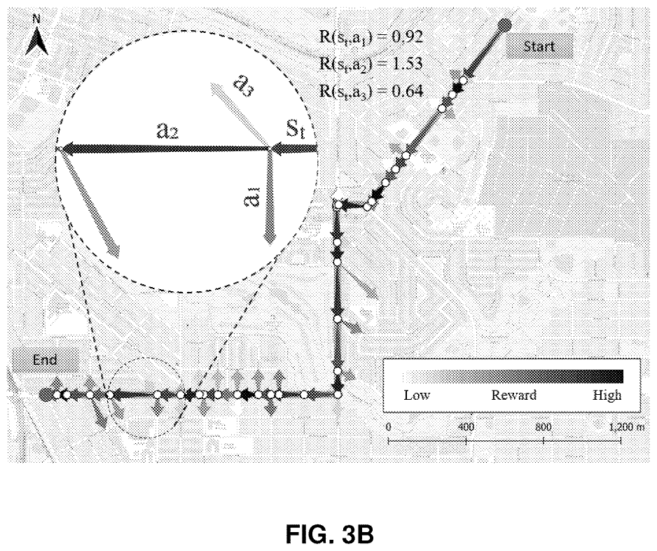

Action: As shown in FIG. 3A, the action at aₜ time t may represent the choice of the next road segment to transition to from the current state. Since each action may correspond to a road segment connected to the current state, aₜ can be defined as transitioning from the current road segment (vₛₜₐᵣₜ, v_{end}, κ) to a new road segment (v_{end}, vₙₑₓₜ, κₙₑₓₜ), where vₙₑₓₜ is the node ID of the next intersection.

Transition model: The transition model T (sₜ, aₜ, sₜ₊₁) may define the probability of moving from state ₛₜ to state sₜ₊₁ given action aₜ. In the MIDIRL model, this transition may be deterministic because the road network graph can define explicit connections between nodes. Therefore, if sₜ=(vₛₜₐᵣₜ, v_{end}, κ) and aₜ=((vₛₜₐᵣₜ, v_{end}, κ), (v_{end}, vₙₑₓₜ, κₙₑₓₜ), the next state sₜ₊₁ is (v_{end}, vₙₑₓₜ, κₙₑₓₜ).

Reward function: The reward function R(s, a) may define the reward or cost associated with transitioning from the current state (s) to the next state by choosing the action (a). As shown in FIG. 3B, if the reward of taking action a₂ at state sₜ, R(sₜ, a₂), is higher than R(sₜ, a₁) or R(sₜ, a₃), then the agent chooses to take action a₂ at the state sₜ. The discount factor, γ, considers the importance of future rewards compared to present rewards.

In the IRL setting, the reward function R is unknown, and the objective is to estimate the reward function from observing expert behavior. The reward structure may be constrained by assuming that states with similar features (f), should have similar rewards. Hence, the reward function may be structured based on state features, expressed as R=g(f,θ). This means that the reward (R) depends on the road features (f) and may be determined by a function (g) with certain parameters (e).

Here in the proposed IRL setting, the historical trajectories and their corresponding ground truth driving paths may be used as expert demonstrations. Specifically, the set of available historical trajectories Γ=ζ₁, ζ₂, . . . , ζₘ along with their ground truth driving paths [symbol] ={Dr₁, Dr₂, . . . , Drₘ} may be used as the expert demonstrations. Each trajectory may be associated with a set of state-action pairs

$${Dr}_{m} = \{ ( {s}_{1}^{m} , {a}_{1}^{m} ) , ( {s}_{2}^{m} , {a}_{2}^{m} ) , … , ( {s}_{t}^{m} , {a}_{t}^{m} ) \} ,$$

where each

$${s}_{i}^{m}$$

represents a state (road segment) and

$${a}_{i}^{m}$$

represents an action (transition to the next road segment).

To learn the reward function from historical data, the model observes the trajectories of expert drivers and extracts relevant features from each road segment, such as road speed, road type and turn type. These features form the input to the reward function. The function g and its parameters θ are learned during the IRL process by optimizing the match between the observed expert trajectories and the trajectories predicted by the model. The optimization process iteratively adjusts θ to maximize the likelihood that the observed behavior is the result of the derived reward function. This involves using algorithms such as gradient descent to find the parameter values that may accurately explain the historical driving patterns.

IRL may capture diverse driving behaviors by modeling the decision-making process of drivers as they navigate through the road network. By observing a wide range of historical trajectories, IRL can identify the underlying reward functions that motivate different driving actions. These reward functions correspond to specific driving behaviors, such as preferring highways over local roads, avoiding toll routes, or optimizing travel time, for example. By learning from diverse historical data, IRL can distinguish between different driving intentions and preferences, allowing the model to accurately represent and predict varied driving behaviors.

In the present disclosure, road segments represent the states, and road features, including road speed, road type, turn type and more (discussed in Section 4.1.2), contribute to the understanding of these state features. By using these features and the IRL framework, the reward function may be determined that guides the route choice behavior of truck drivers.

3.2.1. Incorporating Road Segment Features into State Representations

The present disclosure incorporates various road segment characteristics to define state representations. Each segment may be characterized by factors such as lane count, road type, speed category, turn type, and traffic signal presence. These characteristics may be encoded into an 18-dimensional feature vector I(s). The feature vector may be further refined by considering the segment length. This may be achieved by multiplying the binary indicator vector by the segment length in meters, which may be denoted as I(s)×dist(s).

### 3.3. IRL-Based Map Matching Problem

### 3.3.1. Problem Statement

Given the road network graph G and a set of historical truck trajectories Γ={ζ₁, ζ₂, . . . , ζₘ}, and their corresponding ground truth driving paths D={Dr₁, Dr₂, . . . , Drₘ}, the task is to accurately match new GPS trajectory points ζ_{new}={p₁, p₂, . . . , pₜ} with the corresponding road segments in the graph (G). This involves determining the true driving path Dr_{new}={e₁, e₂, . . . , e_{|Dr}_{_{new}}_{|}}, as an optimal feasible sequence of connected road segments between consecutive GPS points in the new trajectory ζ_{new}. The goal is to maximize the learned reward functions, which can capture diverse driving preferences specific to truck drivers.

### 3.3.2. Problem Formulation

Given the historical trajectory dataset Γ={ζ₁, ζ₂, . . . , ζₘ} and their corresponding ground truth driving paths D={Dr₁, Dr₂, . . . , Drₘ}, convert each driving path Drₘ into a set of state-action pairs

$${Dr}_{m} = \{ ( {s}_{1}^{m} , {a}_{1}^{m} ) , ( {s}_{2}^{m} , {a}_{2}^{m} ) , … , ( {s}_{t}^{m} , {a}_{t}^{m} ) \} ,$$

where each state sᵢ may represent a road segment, and each action aᵢ may represent the transition to the next road segment in the driving path. The conversion can be expressed as:

$${Dr}_{m} = \{ ( {s}_{i}^{m} , {a}_{i}^{m} ) \vert i = 1 , 2 , … , t \} for each {ζ}_{m} ∈ Γ \qquad ( 1 )$$

Using the converted state-action pairs from the historical dataset, apply MIDIRL to learn the reward functions Rₖ that characterize the driving behavior of different driver groups (k). The reward function for each group may be learned by optimizing the likelihood of the observed trajectories under the MaxEnt IRL framework.

For each consecutive pair of GPS points pₜ and pₜ₊₁ in the new trajectory ζ_{new}, all possible candidate road segments for each point may be considered. C(pₜ)={c_{t,1}, c_{t,2}, . . . c_{t,n}} and C(pₜ₊₁)={c_{t+1,1}, c_{t+1,2}, . . . c_{t+1,n}} may be the sets of candidate road segments for pₜ and pₜ₊₁, respectively. For each possible candidate road segment, the state may be defined as the current road segment containing pₜ, and aₜ as the action to move to the next road segment, until reaching the candidate segment containing pₜ₊₁. Consequently, the driving path between pₜ and pₜ₊₁ in the road network can be considered as a set of state-action pairs:

$${s}_{t} = candidate road segment containing {p}_{t} \qquad ( 2 )$$

$${a}_{t} = Action to connect to the next segment towards {p}_{t + 1} \qquad ( 3 )$$

$${Dr}_{{p}_{t} , {p}_{t + 1}} = \{ \{ {s}_{0} , {a}_{0} \} , \{ {s}_{1} , {a}_{1} \} , … , \{ {s}_{i} , {a}_{i} \} \} \qquad ( 4 )$$

The travel cost may be computed by summing the reward function Rₖ values for each state and action connecting pₜ and pₜ₊₁, while also considering the difference in travel time between the estimated and actual travel times. This process can incorporate the driver's behavior for choosing action aₜ during the transition from state sₜ and sₜ₊₁.

$$cost ( {p}_{t} , {p}_{t + 1} ) = {\sum }_{( {s}_{i} , {a}_{i} ) ∈ {Dr}_{{p}_{t} , {p}_{t + 1}}} {R}_{k} ( {s}_{i} , {a}_{i} ) + β \vert Estimated Travel {Time}_{( {p}_{t} , {p}_{t + 1} )} - Actual Travel {Time}_{( {p}_{t} , {p}_{t + 1} )} \vert \qquad ( 5 )$$

The actions that maximize the accumulated reward may be chosen and the travel time difference minimized to determine the best sequence of connected road segments between pₜ and pₜ₊₁:

$$Best {Dr}_{{p}_{t} , {p}_{t + 1}} = arg {max}_{a} [ cost ( {p}_{t} , {p}_{t + 1} ) ] \qquad ( 6 )$$

The final map-matched trajectory may be obtained by connecting all GPS points in the new trajectory using the best connecting road segments.

### 3.4. Overview of MIDIRL

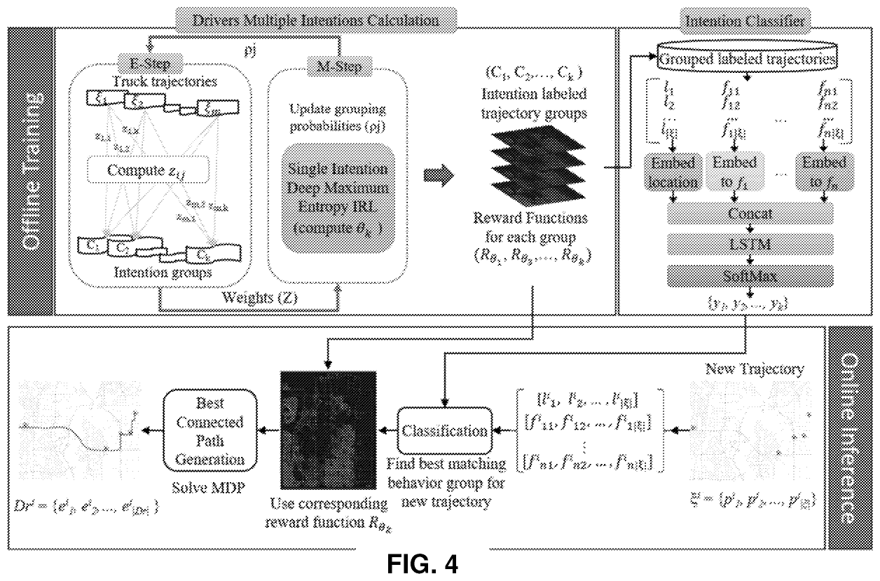

FIG. 4 illustrates the overall framework of the MIDIRL, which may comprise two stages: off-line training and online inference. The offline training stage may include training the model using historical trajectories to understand truck drivers' behaviors. In the online inference stage, the model may apply the acquired knowledge to conduct map matching on the new ultra-low sampling rate GPS trajectories.

The offline training stage begins with capturing multiple driving behaviors within historical trajectories. All historical truck trajectories undergo the multi-intention deep IRL process, which combines expectation-maximization (EM) for grouping trajectories into clusters and deep IRL for learning distinct reward functions that may represent the driving behavior in each group or cluster. This results in grouped historical trajectories and a set of reward functions for each group or cluster. In the subsequent step, a deep learning-based classifier may be trained on trajectories from each group or cluster. Utilizing integrated feature embeddings like location, speed and direction, this classifier can learn and classify new trajectories to the identified driving behavior groups or clusters.

In the online inference stage, the trained classifier may be used to categorize a new low-frequency GPS trajectory into the most closely associated driving behavior group or cluster. Subsequently, the corresponding reward function for that group may be utilized to determine the optimal sequence of road segments between each consecutive GPS point in the new trajectory. This process results in the final map matching outcome for the new trajectory.

### 3.5. MIDIRL Offline Training Stage

### 3.5.1. Drivers Multiple Intentions Calculation

The driver multiple intention calculation module categorizes trajectories into k groups or clusters (corresponding to K intentions), each group/cluster representing distinct driving behaviors, and calculates the reward function for each group, commonly referred to as multiple intentions inverse reinforcement learning (MI-IRL) (Babes et al. 2011). In the MI-IRL problem, it may be assumed that the existence of a finite set of K or fewer intentions, each of which may be represented by a reward function R_{θk}. A collection of historical trajectories Γ={ζ₁, ζ₂, ζₘ} is provided as expert demonstrations. Each intention may be associated with at least one trajectory in this set, and each trajectory is generated by a driver (expert) with one of the intentions. The goal of this module is to efficiently group the set of trajectories into clusters and recover the reward R_{θk} for each group, optimized for each member of the group.

Given that the historical trajectories are unlabeled, an approach to handling multiple driving behaviors in trajectory data is to pre-group trajectories using clustering methods and employing hard assignment, treating each group independently. However, this approach has limitations. Hard clustering may inaccurately assign trajectories to groups, leading to suboptimal representations of driving behaviors. Additionally, addressing individual IRL problems for each group can be computationally expensive and may not account for uncertainty in trajectory grouping. In contrast, MI-IRL with EM (Likmeta et al. 2021) clustering can be beneficial over hard clustering methods like K-means and GMM due to its ability to provide soft assignments that accommodate uncertainty in trajectory grouping, which may result in more accurate and efficient optimization of reward functions for distinct driving behaviors. EM iteratively estimates the parameters of a mixture model, providing soft assignments that accommodate uncertainty in trajectory grouping. It can simultaneously optimize reward functions for each group, resulting in tailored representations of driving behaviors.

The choice of the number of intentions (k) in the MIDIRL framework can impact how the diverse driving behaviors present in historical truck trajectory data is incorporated by the model. The number of intentions generally corresponds to the distinct driving patterns or preferences that drivers exhibit, such as preferring highways over local roads or avoiding toll routes. Determining an appropriate number of intentions can help improve the accuracy of a model of these behaviors and can help improve map matching performance. By choosing an appropriate number of intentions, the diversity of driving behaviors may be incorporated, which may help the model better reflect the range of real-world driving patterns. EM clustering is employed to identify and group similar driving behaviors. The choice of the number of clusters (intentions) in the EM algorithm may be selected to segregate different driving patterns without overlapping (or minimally overlapping), to improve the precision of the map matching.

An optimal number of intentions may allow the model to distinguish between different driving behaviors, which may lead to higher accuracy in mapping GPS points to the correct road segments. The selected number of intentions may help the model generalize better to new trajectories by more accurately classifying them into the appropriate driving behavior groups, which may help ensure improved performance compared to prior methods, even with unseen data. Additionally, the number of intentions can influence the computational efficiency of the model, requiring a balance between capturing sufficient detail in driving behaviors and maintaining manageable computational requirements.

As described in further detail in the examples, to determine the optimal number of intention groups, different values of k were considered and the model's performance evaluated for each case. In Section 4.3.1, more details of how different numbers of intentions may impact the model's performance are presented, which may help identify the number of intentions that may balance the trade-offs between accuracy and computational efficiency for each dataset.

zₘₖ may be defined as the probability that trajectory m belongs to cluster k. Moreover, θₖ may represent the estimated reward weights for cluster k, while pₖ may represent the estimated prior probability of cluster k, which ranges between 0 and 1, indicating what percentage of trajectories belong to cluster k.

During the expectation (E) step, the task is to compute the values of zₘₖ for each trajectory m and cluster k:

$${z}_{mk} = {\prod }_{( s , a ) ∈ {ζ}_{m}} \frac{{π}_{{θ}_{k}} ( s , a ) {ρ}_{k}}{Z} \qquad ( 7 )$$

where Z is the normalization factor. In this phase, the algorithm employs the existing reward weight estimates to compute the probabilities zₘₖ. These probabilities indicate the likelihood that the m^{th} trajectory optimizes the kth reward.

In the M-step, the model updates the hypothesis about the θₖ and pₖ to make them maximally likely under new z values. Updating pₖ may be done by averaging over the probabilities with the trajectories belonging to a cluster:

$${ρ}_{k} = {\sum }_{m ∈ M} \frac{{Z}_{m , k}}{M} \qquad ( 8 )$$

Here, M may represent the count of trajectories within cluster k. The process of updating the reward weights θₖ may include solving a weighted variation of Single Intention Deep MaxEntIRL using the trajectories in the current clusters. Section 3.5.2 describes in more detail how the Single Intention Deep MaxEntIRL algorithm may be used to address the estimation of the single-intention reward function in each cluster.

The algorithm iterates through these two steps until it converges. The result of the process is the estimation of optimized reward functions for each driving intention, enabling accurate modeling of diverse driver behaviors. Algorithm 1 in the table below shows the comprehensive representation of these integrated steps.

Algorithm 1 Multiple Intentions Calculation

```
  1: Input: Historical truck trajectories Γ = {ζ₁, ζ₂, . . . , ζₘ} with corresponding driving
paths [symbol]  = {Dr₁, Dr₂, . . . , Drₘ}, Number of intentions (clusters) K
  2: Output: Reward functions R_{θ}_{₁}_{. . . θ}_{ₖ}, Policies π_{θ}_{ᵢ}_{. . . θ}_{ₖ}, intention labeled trajectory
      clusters C_{1 . . .k}
  3: Initialize ρₗ, . . . , ρₖ
  4: Initialize neural network parameters θ for all k reward functions
  5: while not converged do
  6: E Step:
  7: Extract state-action pairs from the driving path
                ${Dr}_{m} : \{ ( {s}_{1}^{m} , {a}_{1}^{m} ) , ( {s}_{2}^{m} , {a}_{2}^{m} ) , … , ( {s}_{t}^{m} , {a}_{t}^{m} ) \}$
  8:  $Compute {z}_{mk} = {\prod }_{( {s}_{t}^{m} , {a}_{t}^{m} ) ∈ {Dr}_{m}} \frac{{π}_{{θ}_{s}} ( {s}_{k}^{m} , {a}_{k}^{m} ) {ρ}_{k}}{Z}$
  9: M Step:
10: for k ∈ K do
11: ρₖ = Σₘzₘₖ/M
12: Update R_{θ}_{ₖ} and π_{θ}_{ₖ} via Single Intention Deep MaxEntIRL (Section 3.5.2)
      with weight 2ₘₖ on trajectory ζₘ
13: end for
14: end while
15: Return Reward functions R_{θ}_{₁}_{. . . θ}_{ₖ}, Policies π_{θ}_{ᵢ}_{. . . θ}_{ₖ}, clusters C_{1 . . . k}
```

### 3.5.2. Single Intention Deep MaxEntIRL

As mentioned in Section 3.5.1, in the M step of the EM algorithm, the process of updating the reward weights θₖ may involve solving a weighted variation of Single Intention Deep MaxEntIRL using the trajectories in the current clusters. In this section, the details of employing Single Intention Deep MaxEntIRL are described.

Single Intention Deep MaxEntIRL can use historical truck trajectories to address the IRL problem by applying Bayesian inference to maximize L(θ), which may represent the likelihood of observing the given trajectories given the reward weights theta.

$$ℒ θ = log P ( Γ , θ \vert {R}_{θ} ) + {\underbrace{log P ( Γ \vert {R}_{θ} )}}_{{ℒ}_{Γ}} + {\underbrace{log P ( θ )}}_{{ℒ}_{θ}} \qquad ( 9 )$$

Γ represents the dataset of truck trajectories, each comprising a sequence of states and actions. The probability distribution, P(Γ, θ|R_{θ}), may consist of two components: the data term, L_{Γ}, which maximizes the likelihood of the expert's truck trajectory demonstrations Γ, and the regularization term, L_{θ}, which may be the logarithm of the probability distribution governing reward weights. Estimating the scalar network parameter θ* can be done by the following calculation:

$${θ}^{*} = {arg max}_{θ} ℒ ( θ ) = {arg max}_{θ} log P ( Γ , θ \vert {R}_{θ} ) = {arg max}_{θ} {\underbrace{log P ( Γ \vert {R}_{θ} )}}_{{ℒ}_{Γ}} + {\underbrace{log P ( θ )}}_{{ℒ}_{θ}} \qquad ( 10 )$$

The derivative of the data term L_{Γ} concerning the scalar network parameter θ may comprise two aspects. First, it may represent the derivative with respect to the reward Rh: Second, it encompasses the gradient of the reward function R_{θ} with respect to the θ:

$$\frac{\partial {ℒ}_{Γ}}{\partial θ} = {\sum }_{( s , a )} \text{?} \frac{\partial {ℒ}_{Γ}}{\partial {R}_{θ}} \frac{\partial {R}_{θ}}{\partial θ} = {\sum }_{( s , a )} \text{?} ( {μ}_{Γ ( s , a )} - {𝔼}_{[ {μ}_{( s , a )} ]} ) \frac{\partial {R}_{θ}}{\partial θ} = {\underbrace{( {μ}_{Γ} - {𝔼}_{[ μ ]} )}}_{State Visitation Matching} {\frac{\partial {R}_{θ}}{\underbrace{\partial θ}}}_{Backpropagation} \qquad ( 11 )$$

$$\text{?} \text{indicates text missing or illegible when filed}$$

where μ_{Γ(s,a)} signifies the frequency of visitation to state-action pairs, drawing upon the historical truck trajectories as expert demonstrations Γ. This parameter may impact the quantification of how frequently a specific state-action pair appears in the expert's truck trajectory demonstrations. Furthermore, [symbol] denotes the expected visitation count of state-action pairs based on the learned policy. These state-action visitation difference terms can provide insights into the extent of deviation between the behavior of the trained model and the behavior inherent in the expert's historical truck trajectory demonstrations. Drawing from Wulfmeier et al. (2017), L2 regularization techniques may be applied to help prevent overfitting.

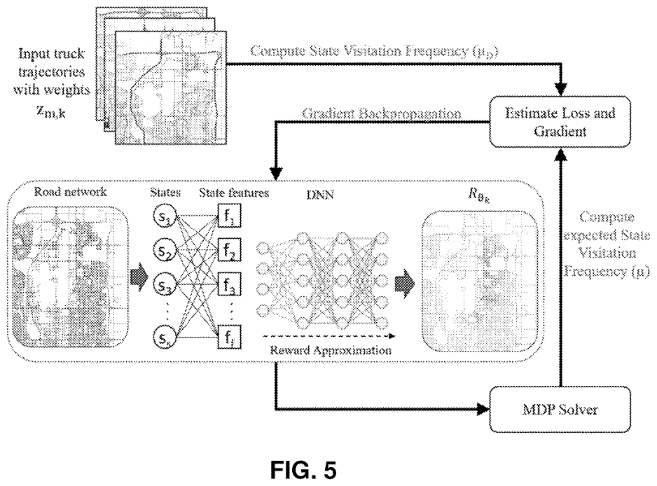

FIG. 5 shows the Single Intention Deep MaxEntIRL training process. During forward propagation, the policy network takes truck historical trajectories as input and generates action probabilities for each state, incorporating driver behavior preferences. These action probabilities may then be utilized to compute the expected state visitation frequency, which reflects the likelihood of each state being visited. Subsequently, during backpropagation, the objective function may be optimized using gradient descent. This optimization process can adjust the policy network parameters to maximize the expected cumulative reward while ensuring alignment with observed state visitation frequencies, effectively learning from the captured driver behaviors in the historical trajectories. This iterative loop continues, alternating between forward propagation and backpropagation until convergence is achieved.

### 3.5.3. Intention Classifier Training

To match a new truck trajectory in the online inference stage, the first step is to determine the cluster to which it belongs, as obtained from the Drivers Multiple Intentions Calculation step. The output of the Drivers Multiple Intentions Calculation step may be a set of historical trajectories labeled with their corresponding group, representing different driving behaviors. The next step of the offline training stage is the training of a deep learning model using the trajectories as input and the corresponding cluster number as labels. This training process can allow the model to learn the underlying patterns and characteristics of the different intention clusters.

A motivation behind using a classifier can be to avoid the computationally intensive process of recomputing the previous steps with every new trajectory. Instead, by training an LSTM-based (long short-term memory) (de Freitas et al. 2021) trajectory classification model, the cluster for a new trajectory may be predicted or determined based on its features. This approach can significantly reduce the computational burden during the online inference phase, making real-time map matching feasible.

As the truck drivers' route choice behavior is modelled as a sequential MDP, where trajectories are represented as a sequence of states and actions, the LSTM architecture may be used for the trajectory classification. The selection of features may impact how accurately the driving behaviors of truck drivers are captured. In some embodiments, the location of each point in the trajectory (latitude and longitude) as well as associated features of the road segment connected to each point may be used. These features may include speed, road type, turn type and other relevant attributes, which are discussed in more detail in Section 4.1.2. The LSTM model takes as input a sequence of these features, effectively representing the trajectory data.

Γ={ζ₁, ζ₂, . . . , ζₘ} may represent the set of historical trajectories, and C={c₁, c₂, . . . . cₘ} may represent the corresponding cluster labels obtained from the Drivers Multiple Intentions Calculation step. For each trajectory ζᵢ, the features Xᵢ may be extracted. The LSTM model may be trained on the feature sequences {X₁, X₂, . . . . Xₘ}, with target labels C. The model architecture, as depicted in FIG. 4, comprises multiple components. To handle the sparse nature of trajectory data, each input feature may be fed into an embedding layer, which may help to represent and process the vectors more effectively. To combine the embedding vectors and create a unified input representation for the LSTM layer, a concatenation layer may be employed. This concatenation layer can join the embedding vectors from different input features, which may facilitate the subsequent processing by the LSTM layer. The LSTM layer may receive the concatenated feature vector as input and performs the necessary computations to extract meaningful patterns. Finally, the output of the LSTM layer may be passed through a fully connected layer with softmax activation. The soft-max function can convert the output of the LSTM layer into a probability distribution across the different trajectory labels.

The trained LSTM model can later be used in the online inference stage to classify new trajectories into the learned driving behavior clusters.

### 3.6. Online Inference Stage

After conducting MIDIRL to infer multiple reward functions for various driving behaviors, the appropriate reward function for a new trajectory may be determined and used to estimate the optimal actions to be taken in the corresponding driving path segments of the road network graph. To achieve this, the new trajectory is classified by using the deep learning-based classifier and then the corresponding reward function is used to estimate the optimal actions. A Q-learning reinforcement learning model may be used to estimate the actions and determine the true traversed routes between GPS points.

### 3.6.1. Classification of New Trajectories

To infer the reward function of a new trajectory after completing the MIDIRL on a set of behavior data consisting of m trajectories, instead of starting MIDIRL from scratch (i.e., repeating the MIDIRL process from the beginning) with all m+1 trajectories, the information already obtained from the pre-computed MIDIRL results may be used. If k distinct reward functions are identified during MIDIRL training, the new trajectory may be classified to one of the groups using the trained LSTM-based model.

When a new trajectory is obtained, the trained LSTM-based model may be employed to predict the label or class of the trajectory. This prediction process may comprise feeding the features of the new trajectory, including its location and relevant road attributes, into the LSTM model. The model can then process the input sequence and generate a probability distribution over the different trajectory labels. By utilizing the softmax activation function in the last layer of the LSTM model, the predicted probabilities for each label may be obtained. By applying the argmax function to the probability distribution, the label with the highest probability may be selected as the predicted class for the new trajectory. When a new trajectory ζ_{new} is observed, its feature sequence X_{new} may be fed into the trained LSTM model. The model can output a probability distribution over the possible clusters, [symbol] ={ [symbol] }, where K is the number of clusters. By applying the softmax activation function in the last layer of the LSTM model, the predicted probabilities for each label may be obtained:

$${\hat{C}}_{new} = softmax ( LSTM ( {X}_{new} ) ) \qquad ( 12 )$$

By applying the argmax function to the probability distribution, the label with the highest probability may be selected as the predicted class for the new trajectory:

$${\hat{C}}_{new} = arg {max}_{k} \text{?} \qquad ( 13 )$$

This approach may help ensure that the new trajectory is classified into one of the previously inferred groups or driving behavior categories. The assigned reward function, obtained from the corresponding group during the classification process, may be be used for completing the route of the trajectory in the next step. Aligning the trajectory with the most suitable reward function may help ensure that the vehicle's movement is consistent with the intended behavior represented by that reward function.

### 3.6.2. Best Connected Path Generation

Following the classification of the new trajectory, the map matching result can be calculated by applying Q-learning to the problem of finding the path that connects each consecutive point of the new trajectory on the road network graph. The algorithm may be trained on the road network graph environment and the goal may be to navigate from a starting node to a target node while maximizing the cumulative reward along the path. The driver's route choice preferences can be represented by the specific reward function chosen according to the classification results for each consecutive point.

Similar to the examples above, the road network graph was represented as a state-action space, where each node in the graph was considered as a state, denoted as s∈S, and each edge was considered as an action, denoted as a∈A. A reward function, denoted as R(s/a), can be defined to reflect the cost of traversing an edge and reaching a new state. Each GPS point in the trajectory may be associated with multiple candidate road segments. These candidates represent potential road segments that the GPS point could be located on. For a given GPS point, the state space can consist of all candidate road segments. Actions may represent the transitions between candidate road segments of consecutive GPS points and the transition model can define the likelihood of moving from one candidate road segment to another, given the action taken, and may be deterministic based on the connectivity of road segments and feasible paths between candidates.

The Q-learning algorithm can explore all possible paths between consecutive GPS points, considering all candidate road segments for each GPS point. The Q-value, Q(s, a), may predict the total reward by choosing action a in state s and then following the optimal policy. For truck trajectory map matching, the update rule for Q-values is:

$${Q}_{new} ( s , a ) = Q ( s , a ) + α [ R ( s , a ) + γ \times max ( Q ( {s}^{′} , {a}^{′} ) ) - Q ( s , a ) ] \qquad ( 14 )$$

Here, Q_{new}(s, a) updates Q-value for state-action pair (s, a). Q(s, a) is the current Q-value, R(s, a) is the immediate reward for action a in state s, a is the learning rate, γ is the discount factor for future rewards and max (Q(s′, a′)) is the highest Q-value for next state s′ and possible actions a′.

During the path evaluation, for each pair of consecutive GPS points (pₜ, pₜ₊₁), the agent evaluates all possible paths between their candidate road segments. The evaluation may consider both the cumulative reward of the path and the travel time between the points. The path with the highest cumulative reward and the travel time closest to the actual travel time may be selected. This may help ensure that the selected path is realistic in terms of the travel time observed in the real world.

The best path may be determined by finding the sequence of road segments that maximizes the cumulative reward while closely matching the actual travel times. This path may represent the most likely route taken by the truck. This iterative process improves the Q-values to guide the map matching algorithm toward selecting the most rewarding actions at each state, ultimately generating the best connected path between consecutive GPS points.

To gain a better understanding of the invention described herein, the following examples are set forth. It should be understood that these examples are for illustrative purposes only. Therefore, they should not limit the scope of this invention in anyway.

### Examples

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

### 4. Evaluations and Results

### 4.1. Experimental Setup

### 4.1.1. Dataset

Two real-world datasets were used in this study to carry out the experiments:

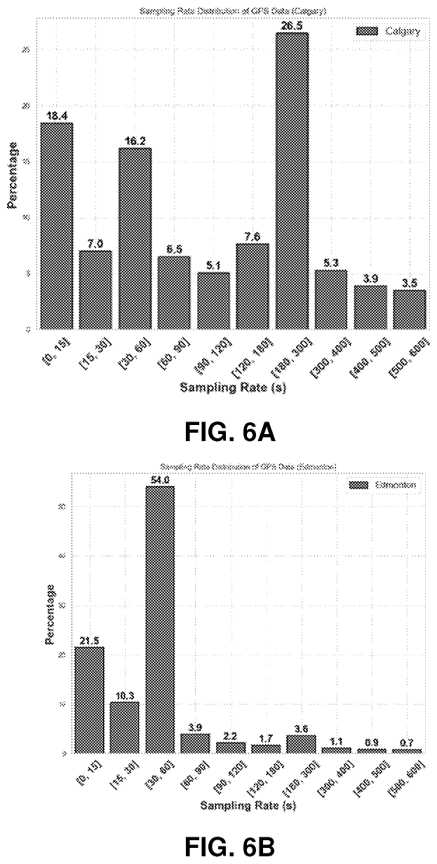

Calgary dataset: The Calgary truck data contain GPS records generated by nearly 10,900 trucks in the Calgary dataset, between 1 Jan. 2019 and 31 Dec. 2019. Trajectories were chosen within the area bounded by [−114.06, 51.20] to [−113.88, 51.05] in longitude and latitude. This area encompasses about 256,000 sampling points for around 4950 trucks. FIG. 6A illustrates the distribution of sampling rates in the dataset.

Edmonton dataset: The dataset contains trajectories produced by over 99,000 trucks within the city of Edmonton between 1 Oct. 2020 and 30 Sep. 2021. Trajectories located within a square area with coordinates ranging from [−113.49, 53.50] to [−113.35, 53.42] in terms of longitude and latitude were selected. This selected area encompasses around 1,560,000 trajectories from approximately 39,000 trucks. FIG. 6B provides information about the distribution of sampling rates in the Edmonton dataset.

Ground-truth dataset: Ground truth data for training and evaluating the MIDIRL model were generated using the methodology from Zheng et al. (2012), applied to datasets from Calgary and Edmonton. High-frequency trajectories (sampled every 15 seconds) were accurately matched to road networks using the HMM map-matching algorithm (Newson and Krumm 2009). These matches were split into training and test subsets with an 8:2 ratio to support model training and evaluation.

### 4.1.2. Road Network and State Features Representation

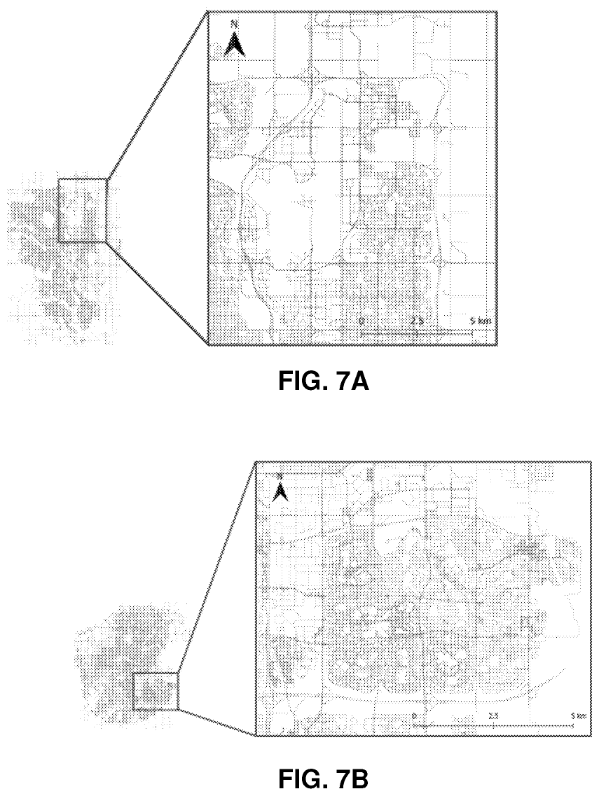

The road networks for Calgary and Edmonton were obtained from the OpenStreetMap (OSM) 1 platform. These networks consist of 9463 and 8928 road segments, respectively, as shown in FIGS. 7A and 7B.

The characteristics of each road segment include number of lanes, type of road segments (highway, major road, local residential or other), speed range (divided into categories <35 km/h, 35-55 km/h, 55-85 km/h, or 85 km/h<), turn type (including no turn, left turn, right turn, hard left turn, hard right turn and U-turn) and traffic light status (whether a road segment is equipped with a traffic light or not).

To capture these features effectively, the features are represented using an 18-dimensional indicator vector I(s). By multiplying the indicator vector with the distance of the road segment in meters, denoted as I(s)×dist(s), a measure that accounts for both the road segment's characteristics and its length was obtained.

4.1.3. Evaluation metrics

To compare the efficiency of map matching methods, three metrics were used: Accuracy by the number of road segments (Accuracy_{N}), computed by dividing the number of correct matched segments by the total number of segments in the trajectories; Accuracy by the length of the segments (Accuracy_{L}), determined by the ratio of the distance of the matching sequence to the total length of all segments within the trajectories; and route mismatch fraction (RMF), which computes the ratio of the total length of mismatches to the total length of the real path (Newson and Krumm 2009).

$${Accuracy}_{N} = \frac{matched road segments}{all segments in trajectory} , \qquad ( 15 )$$

$${Accuracy}_{L} = \frac{\sum length of matched road segments}{length of all segments in trajectory} ,$$

$$RMF = ( {d}_{+} + {d}_{-} ) / {d}_{0} \qquad ( 16 )$$

where d₊ represents the total length of false positive road segments, d₋ denotes the total length of false negative road segments and do is the total length of the actual path. A lower RMF value indicates that the map matching results closely resemble the real path.

| Dataset | Metric | Model | 1 min | 2 min | 3 min | 4 min | 5 min | 6 min | 7 min | 8 min | 9 min | 10 min |
|---|---|---|---|---|---|---|---|---|---|---|---|---|
| Calgary | Accuracy_{N} | HMM | 0.8852 | 0.8623 | 0.8367 | 0.8185 | 0.7835 | 0.7534 | 0.7332 | 0.7213 | 0.6985 | 0.6524 |
| | | ST-Matching | 0.8734 | 0.8456 | 0.8165 | 0.8177 | 0.7642 | 0.7521 | 0.7135 | 0.6941 | 0.6872 | 0.6621 |
| | | L2MM | 0.8934 | 0.8901 | 0.8821 | 0.8604 | 0.8492 | 0.8126 | 0.8093 | 0.7901 | 0.7952 | 0.7873 |
| | | CMM | 0.9390 | 0.9245 | 0.9105 | 0.8507 | 0.8750 | 0.7957 | 0.7905 | 0.8105 | 0.7865 | 0.7738 |
| | | MIDIRL | 0.9387 | 0.9287 | 0.9134 | 0.9045 | 0.8835 | 0.8514 | 0.8456 | 0.8297 | 0.8054 | 0.7924 |
| | Accuracy_{L} | HMM | 0.8742 | 0.8504 | 0.8211 | 0.7934 | 0.7518 | 0.7381 | 0.7013 | 0.6727 | 0.66782 | 0.6384 |
| | | ST-Matching | 0.8677 | 0.8397 | 0.8085 | 0.8084 | 0.7539 | 0.7449 | 0.7023 | 0.6781 | 0.6732 | 0.6325 |
| | | L2MM | 0.8793 | 0.8832 | 0.8755 | 0.8237 | 0.7663 | 0.7954 | 0.7920 | 0.7998 | 0.7824 | 0.7726 |
| | | CMM | 0.9168 | 0.9024 | 0.8861 | 0.8421 | 0.8391 | 0.7963 | 0.7921 | 0.8095 | 0.7764 | 0.7639 |
| | | MIDIRL | 0.9124 | 0.9086 | 0.8991 | 0.8711 | 0.853 | 0.8383 | 0.8391 | 0.8236 | 0.7985 | 0.7878 |
| Edmonton | Accuracy_{N} | HMM | 0.9258 | 0.8879 | 0.8573 | 0.8422 | 0.8101 | 0.7897 | 0.7492 | 0.7080 | 0.7009 | 0.6820 |
| | | ST-Matching | 0.9118 | 0.8795 | 0.8534 | 0.8676 | 0.8148 | 0.7685 | 0.7699 | 0.7429 | 0.7195 | 0.6654 |
| | | L2MM | 0.9637 | 0.9381 | 0.9058 | 0.8745 | 0.8524 | 0.8429 | 0.7951 | 0.7863 | 0.7512 | 0.7548 |
| | | CMM | 0.9860 | 0.9707 | 0.9378 | 0.9017 | 0.9013 | 0.8196 | 0.8063 | 0.8510 | 0.8180 | 0.8125 |
| | | MIDIRL | 0.9775 | 0.9658 | 0.9682 | 0.9497 | 0.9188 | 0.8940 | 0.8879 | 0.8712 | 0.8215 | 0.8320 |
| | Accuracy_{L} | HMM | 0.9179 | 0.8759 | 0.8704 | 0.8251 | 0.7668 | 0.7602 | 0.7153 | 0.7063 | 0.6879 | 0.6576 |
| | | ST-Matching | 0.9111 | 0.8733 | 0.8489 | 0.8569 | 0.7991 | 0.7672 | 0.7304 | 0.7120 | 0.6867 | 0.6452 |
| | | L2MM | 0.9649 | 0.8982 | 0.8915 | 0.8420 | 0.8239 | 0.7862 | 0.7616 | 0.7741 | 0.7554 | 0.7298 |
| | | CMM | 0.9718 | 0.9204 | 0.9127 | 0.8589 | 0.8811 | 0.8122 | 0.8079 | 0.8419 | 0.8230 | 0.8021 |
| | | MIDIRL | 0.9580 | 0.9540 | 0.9351 | 0.9147 | 0.8871 | 0.8634 | 0.8643 | 0.8483 | 0.8304 | 0.8351 |

Note:
Best results are highlighted in bold.

Additionally, for each trajectory, the average matching time was calculated as:

$$Average matching time = \frac{\sum running time for trajectories}{\vert of test trajectories \vert} \qquad ( 17 )$$

### 4.2. Overall Performance of MIDIRL

The effectiveness of MIDIRL was evaluated by comparing it to conventional approaches, including HMM (Newson and Krumm 2009), ST-Matching (Lou et al. 2009), L2MM (Jiang et al. 2022) and CMM (Bian et al. 2020) which is a more recent advanced model developed for low sampling rate trajectories.

### 4.2.1. Accuracy

Table 1 presents the accuracy results of four approaches evaluated using GPS trajectory datasets with sampling rates ranging from 1 minute to 10 minutes.

Overall, as the sampling interval increases, indicating a decrease in sampling frequency, the accuracy of all algorithms declines across both datasets. However, MIDIRL-matching, CMM-matching and L2MM consistently show better performance compared to ST-Matching and HMM-matching, especially at lower sampling rates.

In the city of Calgary dataset, with a sampling interval of one minute, CMM exhibits the best performance in terms of both accuracy_{N} and accuracy_{L} with a slight margin over MIDIRL. However, MIDIRL outperforms all other methods from 2-minute to 10-minute intervals in the Calgary dataset. For instance, with a two-minute sampling interval, MIDIRL achieves an accuracy_{N} of 0.9287 and an accuracy_{L} of 0.9086, surpassing CMM, which achieves 0.9245 and 0.9024, respectively. Compared to HMM, ST-Matching, L2MM and CMM, MIDIRL model shows improvements of 7.7%, 9.8%, 3.9% and 0.5% in accuracy_{N}, and 6.8%, 8.2%, 1.5% and 0.6% in accuracy_{L}, respectively.

Furthermore, as the time interval increases, MIDIRL continues to outperform other models, widening the performance gap. For example, when conducting map matching on GPS data with a sampling interval of 10 minutes in the Calgary dataset, MIDIRL achieves an accuracy_{N} of 0.7924 and an accuracy_{L} of 0.7878. This represents significant improvements over HMM (0.6524 and 0.6384), ST-Matching (0.6621 and 0.6325), L2MM (0.7873 and 0.7726) and CMM (0.7738 and 0.7639), with accuracy_{N} improvements of 21.4%, 19.5%, 5.6% and 2.5%, respectively, and accuracy_{L} improvements of 23.3%, 24.5%, 1.9% and 3.1%, respectively. L2MM performs better than CMM at the 10-minute interval, achieving an accuracy_{N} of 0.7873 and an accuracy_{L} of 0.7726, yet still falls short of MIDIRL, demonstrating the improvements of the model of the present disclosure.

The results obtained from the Edmonton dataset show a similar trend to those of the Calgary dataset, albeit with slight variations in the numerical values. MIDIRL consistently outperforms the other four models as the sampling rate increases, indicating its improved performance in handling increasingly sparse GPS data. Notably, there is a significant decrease in accuracy observed for ST-Matching and HMM-Matching after a five-minute interval. In contrast, MIDIRL consistently performs well, even with ultra-sparse GPS points where the distance between consecutive points can be several kilometers. This highlights its effectiveness in accurately determining the true driving path by considering different driving behaviors from historical trajectories. Furthermore, CMM-Matching also exhibits robust performance, ranking second after MIDIRL, on sparse trajectories, emphasizing the importance of leveraging historical data to improve map-matching accuracy, even at very low sampling rates. L2MM shows commendable performance but falls short of MIDIRL and CMM in higher intervals, demonstrating its limitations in capturing the full extent of driving behavior and network features in ultra-low-frequency data scenarios.

### 4.2.2. Route Mismatch Fraction

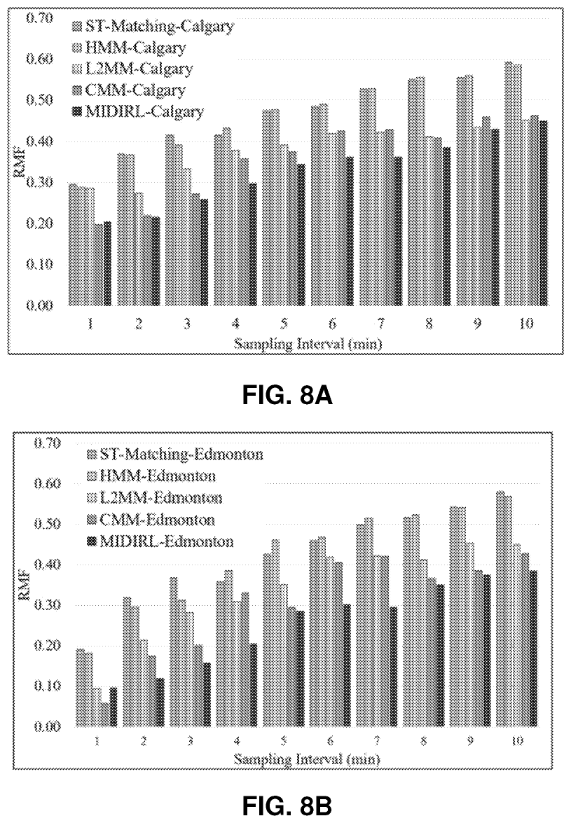

Furthermore, the map-matching effectiveness of the four approaches in terms of RMF are compared in FIGS. 8A and 8B. As the sampling interval increases, indicating a higher number of sparse GPS samples, the RMF increases for all models in both datasets. MIDIRL consistently outperforms the other models across all sampling rates, ranging from 2 minutes to 10 minutes. CMM and L2MM models vary in their performance, with CMM often performing better than L2MM at certain intervals.

Notably, in the Calgary dataset with a 10-minute sampling interval, MIDIRL achieves an RMF of 0.4495, whereas CMM, L2MM, HMM and ST-Matching achieve RMFs of 0.4627, 0.4509, 0.5873 and 0.5925, respectively. Similarly, in the Edmonton dataset with a 10-minute sampling interval, MIDIRL achieves an RMF of 0.3841, outperforming CMM (0.4287), L2MM (0.4611), HMM (0.5699) and ST-Matching (0.5813). This comparison of mismatch fractions reaffirms MIDIRL's improvements over other methods due to its ability to learn from historical data and apply that knowledge in the map-matching process.

### 4.2.3. Running Time Efficiency

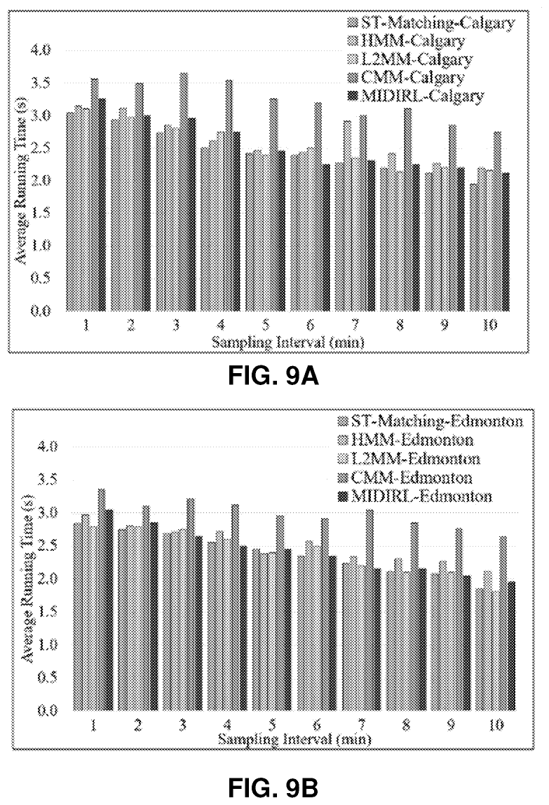

The running time of the four map-matching approaches was compared in this study. FIG. 9 illustrates the average trajectory matching time of the four models for both datasets. The time consumption reported here pertains to the evaluation of the MIDIRL model on the test dataset. It was observed that as the sampling interval increases, all approaches exhibited a decrease in matching time. This decrease may be attributed to the reduced number of GPS samples available for matching, resulting in a shorter running time for all methods. Among all methods, the CMM matching algorithm consistently had the longest matching time at any sampling interval. This is likely because the model needs to query all historical points from the database and retrieve closer points to the trajectory. In contrast, the ST-Matching, HMM and L2MM methods exhibited shorter running times compared to CMM. L2MM, in particular, showed running times similar to ST-Matching and HMM and occasionally performed better than MIDIRL. For example, in the Calgary dataset at a one-minute interval, L2MM has a running time of 3.10, which is shorter than MIDIRL at 3.25. Similarly, in the Edmonton dataset at a 10-minute interval, L2MM has a running time of 1.81, which is shorter than MIDIRL at 1.95. When the sampling interval was shorter than five minutes in the Calgary dataset and less than six minutes in the Edmonton dataset, both ST-Matching, HMM and L2MM methods showed faster matching times than MIDIRL. This could be because there are fewer candidate paths to search in these algorithms when the interval is shorter. However these methods had less satisfactory map matching accuracy and RMF scores. MIDIRL, despite having a slightly longer running time at higher sampling intervals, demonstrated running time efficiency in both datasets at lower sampling intervals.

### 4.3. Sensitivity Analysis of MIDIRL

This subsection examines the sensitivity of MIDIRL to several parameters: the number of intentions, training data size, and trajectory density.

### 4.3.1. Effect of Number of Intentions

This section examines how varying the number of driving behavior groups (intentions) affects the MIDIRL algorithm's performance. Experiments were conducted with intentions ranging from 1 to 15, training the model with different numbers, and assessing its performance on datasets with a one-minute sampling interval.

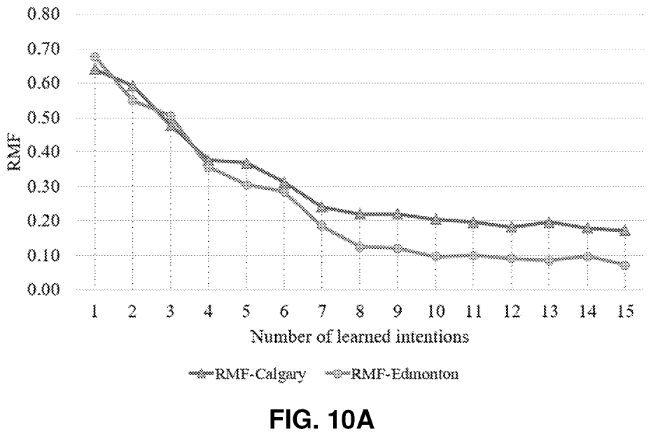

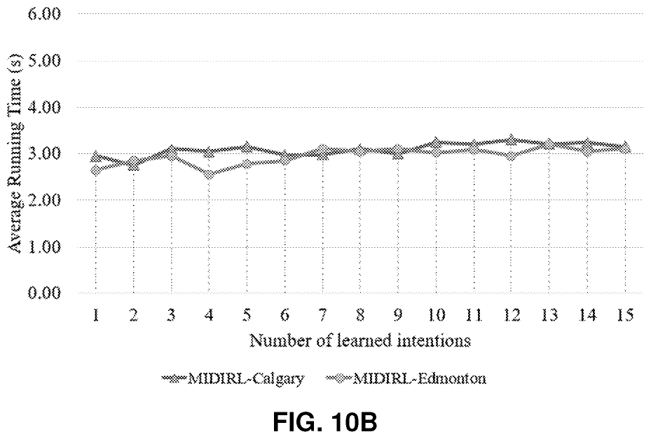

The results of these experiments are presented in FIG. 10(a), which illustrates the matching accuracy of the model on one-minute interval data under different intention sizes. The results indicate that the RMF factor generally decreases as the number of intentions in the algorithm increases. This may suggest that incorporating more intentions may allow for a better understanding and representation of different driving behaviors, which may lead to improved performance in matching GPS points to the corresponding routes. However, after reaching eight intentions, the changes in the RMF can become less significant. Up to the 15th intention, the changes in RMF were very slight. Considering that increasing the number of intentions can also affect the computation time of the algorithm in the offline training stage, selecting 10 intentions in some embodiments can strike a balance between accuracy and computational efficiency. Therefore, based on the experimental results, 10 intentions were used in the model as it provides a good trade-off between accuracy and the training time of the algorithm for this embodiment. Other intentions may be selected as appropriate for the context.

FIG. 10(b) shows the running time analysis of MIDIRL with different numbers of learned intentions. Increasing the number of intentions dis not significantly affect the average running time for either dataset. This is because the online inference phase comprises two stages: trajectory classification and route generation. In trajectory classification, the new trajectory may be classified into an existing group based on similarity to learned behaviors, which can be not sensitive or less sensitive to the number of intentions. Similarly, in route generation, the corresponding reward function may be used to generate the route, and the number of intentions may not substantially impact the running time.

### 4.3.2. Effect of Training Data Size

In order to evaluate the effect of the size of training data on the performance of MIDIRL and determine the optimal training data size, experiments were conducted to train the model using different historical trajectory sizes and evaluate the map matching accuracy using the city of Calgary dataset with different sampling intervals.

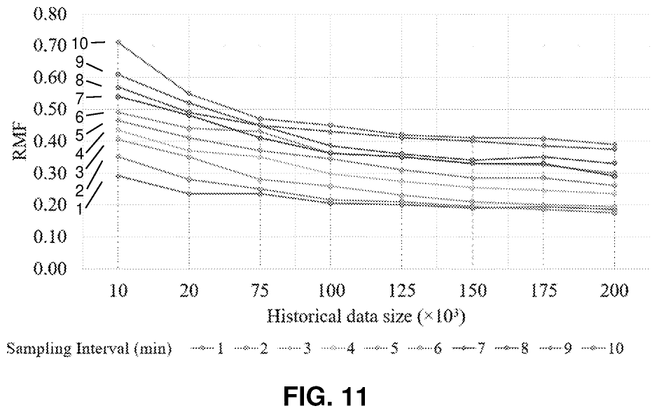

The results are shown in FIG. 11, which shows the accuracy of MIDIRL under different sizes of training data. It can be observed that the accuracy of the model increases as the amount of training data increases. This may be because more training data allow the model to learn more effective feature expectations and identify more comprehensive patterns, leading to better map matching performance.

The experiments further showed that MIDIRL can be robust to the training data size. Even with a modest quantity of training data, satisfactory performance was obtained, which can further enhance training efficiency. Furthermore, upon increasing the training data size to more than 125,000, the model's performance remained relatively consistent, which may suggest that further increasing the amount of training data could become redundant once the model is fully trained. Overall, these findings may suggest that the model of the present disclosure can achieve high performance with a modest amount of training data and that increasing the training data size beyond a certain point may not always lead to significant improvement in map matching accuracy.

### 4.3.3. Effect of Trajectory Density

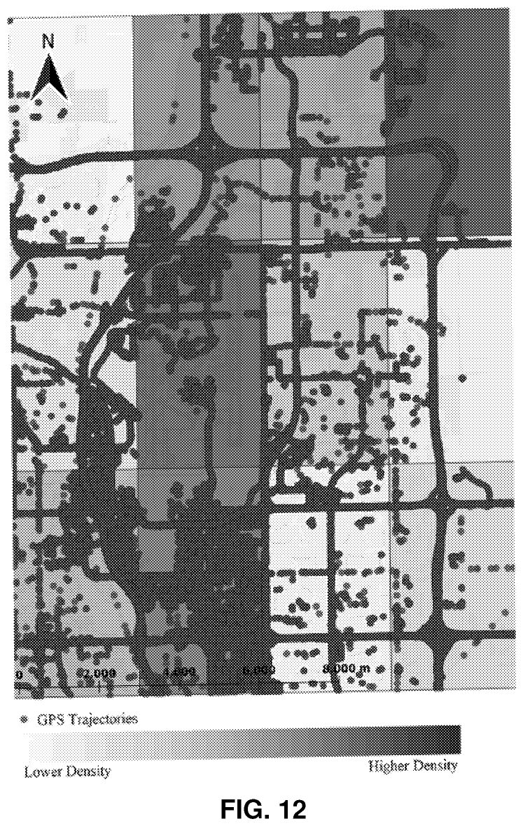

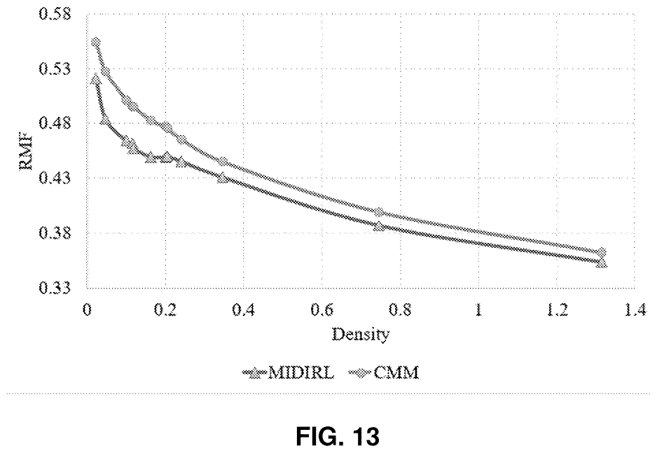

To assess how well MIDIRL performs in regions with sparse historical data, experiments were conducted using the City of Calgary dataset. To begin, as shown in FIG. 12 the study area was divided into 12 equal-sized regions and the density of trajectories within each region was calculated, which is determined by the proportion of GPS points relative to the total length of the roads in that particular region. The map matching accuracy of the model was then calculated in each area for the time interval of one minute, and the results are shown in FIG. 13.

The findings show that both models' performances can be negatively impacted in areas with lower trajectory density (e.g. less than 0.1), as it can be challenging to identify the correct driving paths in such areas. However, MIDIRL is still able to perform map matching in these areas better than CMM due to its ability to leverage feature expectations in different driving behaviors and pattern recognition. It should be noted that without any historical trajectories, the model may not necessarily accurately generate correct driving paths.

### 4.4. Driving Behavior Visualization and Understanding

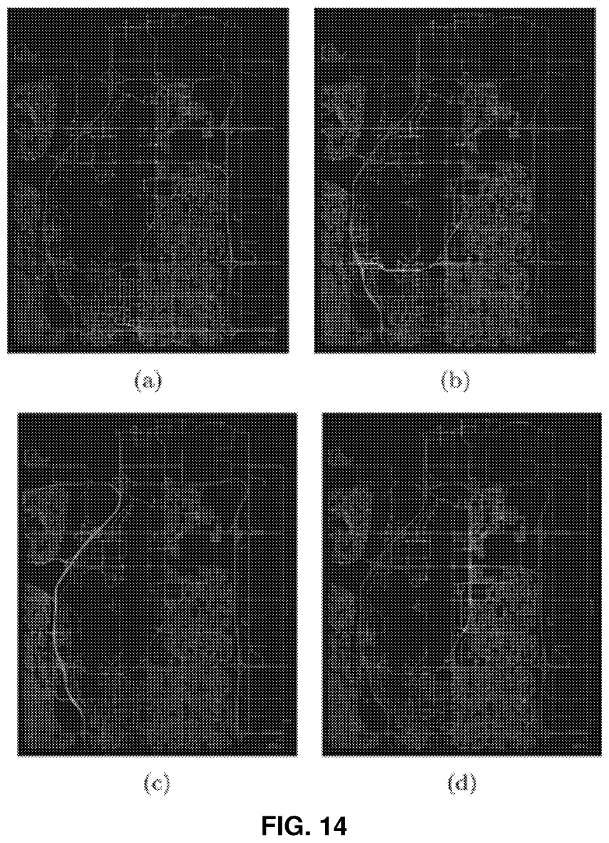

To understand distinct driving behaviors, visualizations of four representative driving behaviors learned from MIDIRL using a dataset of 125,000 trajectories from Calgary are provided. These behaviors are visualized by assigning the behavior reward function as an attribute to the road network graph edges. Brighter colors in the color bar indicate higher rewards. FIG. 14 shows four distinct patterns, each with unique characteristics, which we describe in detail below.

Pattern (a) in FIG. 14 corresponds to trucks that frequently make stops in the industrial part of the city for either pickup or delivery purposes. Upon closer examination, these areas appear to predominantly consist of storage and industrial facilities. The trucks follow specific routes that traverse through these industrial zones and subsequently connect to the main roads. This pattern may suggest a distinct behavior among trucks operating in these regions, influenced by the specific demands and characteristics associated with roads. Pattern (b) in FIG. 14 exhibits trajectories that appear to be primarily concentrated in the western part of the case study. These trajectories predominantly follow a west-to-east direction along major roads, likely indicating a specific traffic pattern in those regions. The consistent use of these routes may suggest a preference for major arterial roads that provide direct and efficient access across the city. This behavior likely reflects the high volume of freight movement and the need for reliable and fast transportation routes in the western part of Calgary. In contrast, pattern (c) in FIG. 14 shows trajectories moving between the northern and southern regions of Calgary, mainly using the Deerfoot Trail highway. These paths appear to be primarily used by trucks entering or exiting the city from the north or south, as well as those traveling to destinations within these areas. This pattern indicates the likely importance of Deerfoot Trail as a major freight corridor that supports the flow of goods through the city, highlighting its role in regional and intercity transportation. Lastly, pattern (d) in FIG. 14 appears to capture the road routes commonly taken by trucks traveling to or from the airport. Surrounding the airport, there are numerous storage and industrial areas, which serve as origins or destinations for truck movements. The pattern appears to indicate the major roads preferred by truck drivers who transport goods between the airport and other industrial sectors of the city.

The MIDIRL algorithm can find these patterns by considering various road features such as the number of lanes, type of road segments, speed range, turn type and traffic light status. By incorporating these features, the algorithm can accurately capture and model the complex decision-making processes of truck drivers. For instance, the preference for highways in pattern (c) can be attributed to the higher speed limits and fewer interruptions, which are crucial for long-distance travel. Similarly, the frequent stops in pattern (a) can align with the presence of industrial facilities that require regular deliveries and pickups. By leveraging these detailed road features, the MIDIRL algorithm not only identifies the routes taken by trucks but also understands the underlying reasons for these choices.

### 4.5. Case Study

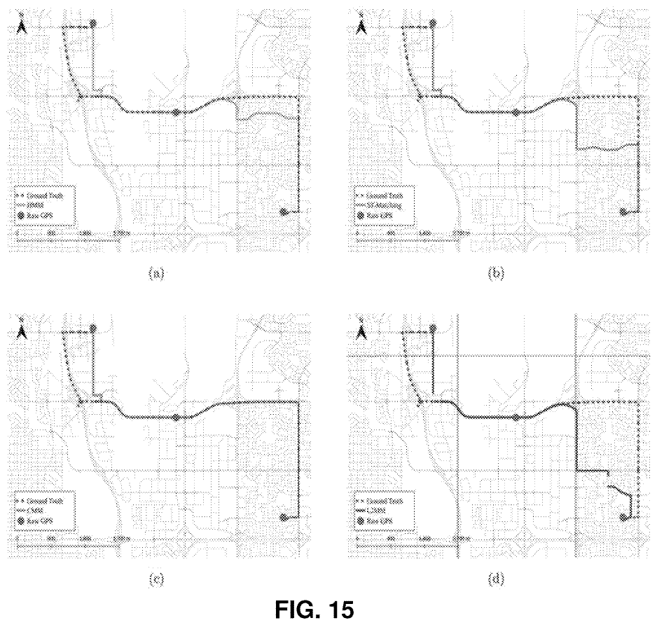

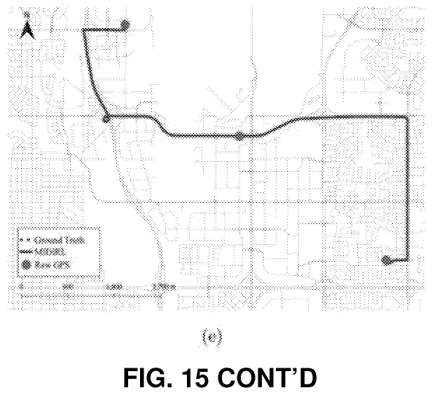

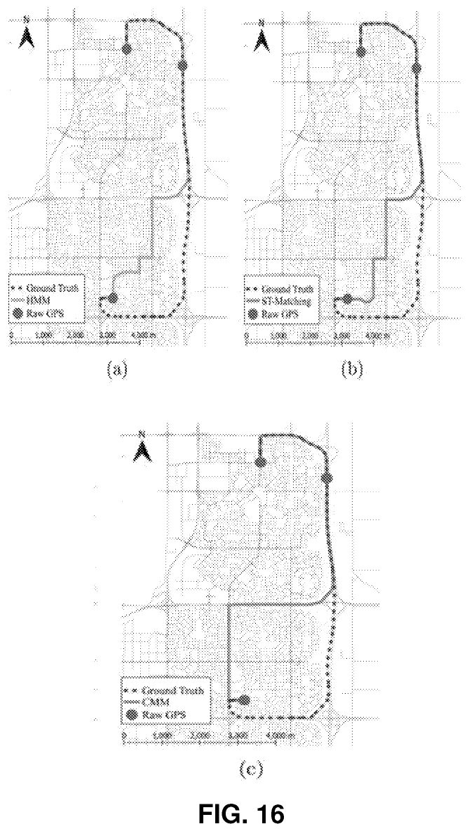

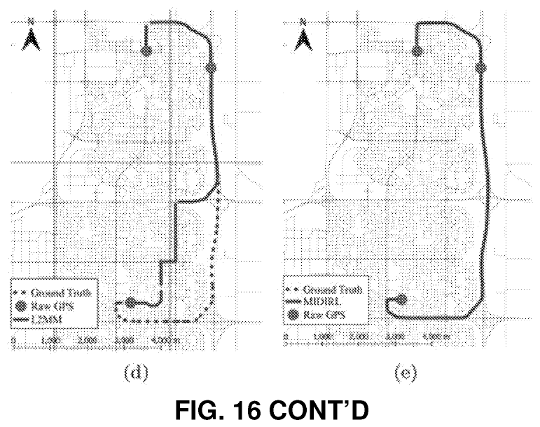

To further assess the effectiveness of MIDIRL in performing map matching, sample scenarios that visually illustrate MIDIRL performance over baseline methods are provided. Two distinct cases are provided with varying sampling time intervals to show the map matching results in FIGS. 15 and 16.

FIG. 15 compares the map matching results of three baselines and MIDIRL. Initially, all baselines chose the shorter route, while the ground truth shows the driver took the longer highway route. MIDIRL appeared to accurately estimate this path by considering road features and driving preferences. When GPS points are sparse, HMM and ST-Matching tend to select shorter paths, ignoring past driving patterns. In contrast, CMM and MIDIRL can identify the correct route by learning from historical data. Although CMM performs better than HMM and ST-Matching, it still struggles with route sequences. MIDIRL demonstrates improvements by integrating road characteristics and learned driving patterns, to more accurately estimate paths even with few GPS points.

In FIG. 16, we showcase the map matching outcomes with GPS points with a sampling interval of 10 minutes. It appears that as the GPS data become sparser, the performance of basic algorithms declines, with nearly half of the route being incorrectly matched. Both HMM and ST-Matching algorithms exhibited relatively similar results, attempting to link points via the shortest or fastest path available. On the other hand, the CMM algorithm links GPS points using the most common path in the historical trajectories, which we can observe may not always align with the actual driver route preference. In contrast, MIDIRL achieves more accurate results by considering road features and learning diverse driver behaviors from historical trajectories.

### 5. Limitations and Future Work

While MIDIRL has demonstrated significant improvements in map matching accuracy and robustness, there are limitations. In this section, we discuss these limitations and outline potential future directions to enhance the performance and adaptability of the model.

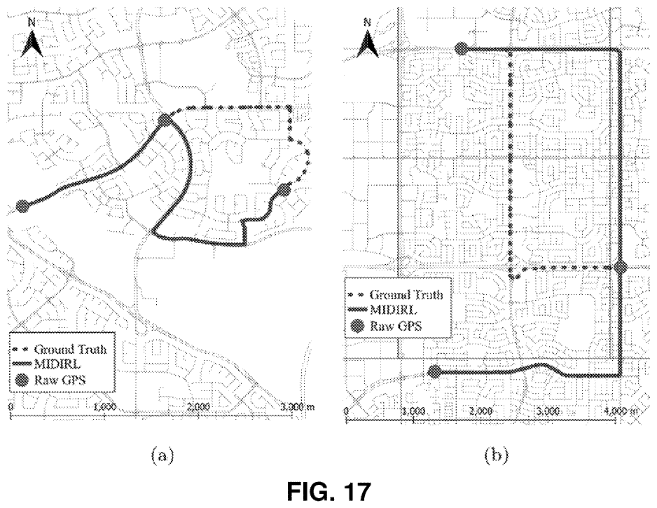

FIG. 17(a) presents a scenario from an area of the city with a low density of historical data, as indicated in FIG. 12. In regions with insufficient historical data and limited diverse behaviors, the algorithm appears to struggle to perform optimally. This appears to be especially true when road features across the area are relatively similar. In such cases, MIDIRL may not accurately capture the preferred driving paths, potentially leading to less reliable map matching results. This may suggest a limitation of the current model in handling areas with sparse and homogeneous historical data. A potential approach to address this limitation can be integrating additional context-aware features. Incorporating external data such as real-time traffic conditions and driver profiles could enhance the model's ability to infer driving behaviors in areas with sparse historical data. Additionally, leveraging transfer learning techniques to utilize data from similar regions with richer datasets could help improve the model's performance.

Additionally, FIG. 17(b), shows another potential limitation of the model where the new trajectory has an equal probability of belonging to two different intention groups. In these situations, where the probability of the new trajectory matching either of the two groups is the same, the model might randomly choose one of the behaviors, potentially causing inaccuracies. Although these situations are very rare, one such instance was observed. By considering additional features such as the time of day, day of the week, or traffic conditions, these inaccuracies can be reduced. Incorporating these dynamic features would allow the model to better differentiate between similar driving patterns.

Lastly, the embodiments described in the present disclosure for the MIDIRL framework currently use a predefined number of intentions, which can include trial and error during training, and which may be more time-consuming and/or more computationally intensive. To overcome this, it may be possible to modify non-parametric clustering methods to automatically determine the optimal number of intentions without requiring excessive computational time. Implementing these additional or alternative clustering techniques may streamline the training process and may improve the model's efficiency, which may further make it more user-friendly and adaptable to different datasets and scenarios.

### 6. Conclusions

The present disclosure provides, a MIDIRL model for improved mapping low-quality GPS trajectories in map matching tasks. MIDIRL algorithm leverages deep IRL to uncover the underlying relationship between road characteristics and drivers' preferences and route choices. To evaluate the effectiveness of MIDIRL, experiments using two real-world datasets were performed. The experimental findings confirm that MIDIRL achieves the highest matching accuracy and efficiency compared to other methods studied while maintaining a reasonable processing time trade-off.

The MIDIRL map matching method can be integrated into existing transportation systems by incorporating its advanced capabilities into the current GPS tracking and navigation infrastructure. This integration may include initially feeding historical GPS data into the MIDIRL framework to allow it to learn and model diverse driving behaviors and preferences. Once the model is trained, it can process real-time GPS signals to accurately match vehicle trajectories to the correct road segments. This precise map matching can be embedded into transportation management systems to enhance route planning and navigation, enabling dynamic route adjustments in response to real-time traffic conditions and road changes. Moreover, transportation systems can use MIDIRL to improve fleet monitoring and management by providing accurate tracking data. Logistics managements can leverage this accurate trajectory data to optimize delivery schedules, improve shipment tracking and promptly address any deviations or delays, enhancing overall supply chain efficiency.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not necessarily provided as to whether the embodiments described herein are implemented as a computer software, computer hardware, electronic hardware, or a combination thereof.

In at least some embodiments, one or more aspects or components may be implemented by one or more special-purpose computing devices. The special-purpose computing devices may be any suitable type of computing device, including desktop computers, portable computers, handheld computing devices, networking devices, or any other computing device that comprises hardwired and/or program logic to implement operations and features according to the present disclosure.

Embodiments of the disclosure may be represented as a computer program product stored in a machine-readable medium (also referred to as a computer-readable medium, a processor-readable medium, or a computer usable medium having a computer-readable program code embodied therein). The machine-readable medium may be any suitable tangible, non-transitory medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations may also be stored on the machine-readable medium. The instructions stored on the machine-readable medium may be executed by a processor or other suitable processing device, and may interface with circuitry to perform the described tasks.

The structure, features, accessories, and/or alternatives of embodiments described and/or shown herein, including one or more aspects thereof, are intended to apply generally to all of the teachings of the present disclosure, including to all of the embodiments described and illustrated herein, insofar as they are compatible. Thus, the present disclosure includes embodiments having any combination or permutation of features of embodiments or aspects herein described.

In addition, the steps and the ordering of the steps of methods and data flows described and/or illustrated herein are not meant to be limiting. Methods and data flows comprising different steps, different number of steps, and/or different ordering of steps are also contemplated. Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The embodiments according to the present disclosure are intended to be examples only. Alterations, modifications and variations may be effected to the particular embodiments by those of skill in the art without departing from the scope, which is defined solely by the claims appended hereto.

The terms “a” or “an” are generally used to mean one or more than one. Furthermore, the term “or” is used in a non-exclusive manner, meaning that “A or B” includes “A but not B,” “B but not A,” and “both A and B” unless otherwise indicated. In addition, the terms “first,” “second,” and “third,” and so on, are used only as labels for descriptive purposes, and are not intended to impose numerical requirements or any specific ordering on their objects.

### REFERENCES

Babes, M., et al., 2011. Apprenticeship learning about multiple intentions. In: Proceedings of the 28th international conference on international conference on machine learning (ICML′11). Madison, WI: Omnipress, 897-904.
Barnes, M., et al., 2023. Massively scalable inverse reinforcement learning in Google maps. arXiv preprint arXiv: 2305.11290.
Bian, W., Cui, G., and Wang, X., 2020. A trajectory collaboration based map matching approach for low-sampling-rate GPS trajectories. Sensors, 20 (7), 2057.
Bighashdel, A., et al., 2021. Deep adaptive multi-intention inverse reinforcement learning. In: Machine learning and knowledge discovery in databases. Research track: European conference, ECML PKDD 2021, Proceedings, Part I 21, 13-17 September, Bilbao, Spain. Springer International Publishing, 206-221.
Chen, B. Y., et al., 2014. Map-matching algorithm for large-scale low-frequency floating car data. International Journal of Geographical Information Science, 28 (1), 22-38.
Chen, C., et al., 2020. Trajcompressor: an online map-matching-based trajectory compression framework leveraging vehicle heading direction and change. IEEE Transactions on Intelligent Transportation Systems, 21 (5), 2012-2028.
Choi, J. and Kim, K. E., 2012. Nonparametric Bayesian inverse reinforcement learning for multiple reward functions. In: Proceedings of the 25th international conference on neural information processing systems—Volume 1 (NIPS'12). Red Hook, NY: Curran Associates Inc., 305-313.
de Freitas, N. C. A, et al., 2021. Using deep learning for trajectory classification in imbalanced dataset. The International FLAIRS Conference Proceedings, 34. https://doi.org/10.32473/flairs. v34i1.128368
Fahad, M., Chen, Z., and Guo, Y., 2018. Learning how pedestrians navigate: a deep inverse reinforcement learning approach. In: 2018 IEEE/RSJ international conference on intelligent robots and systems (IROS), Madrid, Spain. IEEE, 819-826. https://doi.org/10.1109/IROS.2018.8593438
Feng, J., et al., 2020. DeepMM: deep learning based map matching with data augmentation. IEEE Transactions on Mobile Computing, 21, 2372-2384.
Fernando, T., et al., 2021. Deep inverse reinforcement learning for behavior prediction in autonomous driving: accurate forecasts of vehicle motion. IEEE Signal Processing Magazine, 38 (1), 87-96.
Gleave, A. and Habryka, O., 2018. Multi-task maximum entropy inverse reinforcement learning. arXiv preprint arXiv: 1805.08882.
Hirakawa, T., et al., 2018. Can AI predict animal movements? Filling gaps in animal trajectories using inverse reinforcement learning. Ecosphere, 9 (10), e02447.
Huang, Y., et al., 2018. Frequent pattern-based map-matching on low sampling rate trajectories. In: 2018 19th IEEE international conference on mobile data management (MDM), Aalborg, Denmark. IEEE, 266-273. https://doi.org/10.1109/MDM.2018.00046
Huang, Z., et al., 2021. Survey on vehicle map matching techniques. CAAI Transactions on Intelligence Technology, 6 (1), 55-71.
Jagadeesh, G. R. and Srikanthan, T., 2017. Online map-matching of noisy and sparse location data with hidden Markov and route choice models. IEEE Transactions on Intelligent Transportation Systems, 18 (9), 2423-2434.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

1. A method of map matching, the method comprising:
I. obtaining location data of a vehicle on a road network;
II. using a classifier to classify the location data to a cluster for generating classified location data; and
III. determining a driving path of the vehicle on the road network based on the classified location data by:
determining possible driving paths on the road network between at least two data points of the location data, and
applying a policy of the cluster to select the driving path from the possible driving paths;
wherein:
the classifier is a trained machine learning model that is trained on known driving data labelled with cluster labels of clusters;
the known driving data comprises known location data and known road segment features;
each of the clusters comprises a set of the known driving data and a reward function that are determined by:
training policies for the clusters using an inverse reinforcement learning (IRL) model, wherein the IRL model comprises:
the known road segment features as inputs to the reward function for each of the clusters, and
known driving paths corresponding to the known driving location as expert behavior; and
the clusters and each set of the known driving data corresponding to the clusters are labelled with the cluster labels.

2. The method of claim 1, wherein the trained machine learning model is a deep neural network.

3. The method of claim 1, wherein training policies for the clusters further comprises using expectation-maximization clustering to form the clusters of the known driving data based on road segment features.

4. The method of claim 3, wherein the road segment features comprise one or more of speed limit, speed range, speed category road type, lane count, traffic light status, traffic light presence, or turn type.

5. The method of claim 1, wherein the inverse reinforcement learning model comprises a deep inverse reinforcement learning model.

6. The method of claim 1, wherein applying a policy of the cluster to select the driving path from the possible driving paths further comprises matching the driving path to a travel time.

7. The method of claim 1, wherein determining possible driving paths of the road network further comprises determining possible road segments at each node of the road network, and applying a policy of the cluster to select the driving path from the possible driving paths further comprises applying the policy to select a road segment from the possible road segments.

8. The method of claim 1, wherein a Q-learning algorithm is used to determine possible driving paths on the road network.

9. The method of claim 1, wherein each of the clusters represents a driving behavior.

10. The method of claim 1, wherein the driving behavior comprises one or more of a road type preference, toll avoidance, cargo handling, or optimized travel time.

11. The method of claim 1, wherein a total number of clusters is predefined.

12. The method of claim 1, wherein the location data is received at a sampling rate above 2 minutes.

13. A method for training a multi-intention inverse reinforcement learning model comprising:
obtaining driving data and known driving paths of a plurality of vehicles on a road network, the driving data comprising known location data and known road segment features;
applying an expectation-maximization model to categorize two or more sets of the driving data to two or more clusters, respectively; and
training policies for each of the two or more clusters using an inverse reinforcement learning (IRL) model, wherein the IRL model comprises:
the known road segment features as inputs to the reward function for each of the clusters, and
the known driving paths corresponding to the driving as expert behavior.

14. The method of claim 13, wherein the clusters and each set of the driving data corresponding to the two or more clusters are labelled with cluster labels.

15. The method of claim 13, wherein the IRL model comprises a deep IRL model.

16. The method of claim 13, wherein each of the two or more clusters represents a driving behavior.

17. The method of claim 16, wherein the driving behavior comprises one or more of a road type preference, toll avoidance, cargo handling, or optimized travel time.

18. The method of claim 13, wherein the road segment features comprise one or more of speed limit, speed range, speed category road type, lane count, traffic light status, traffic light presence, or turn type.

19. The method of claim 13, wherein a total number of clusters is predefined.

20. A non-transitory computer-readable medium storing instructions which, when executed, cause one or more processors to perform operations comprising:
I. obtaining location data of a vehicle on a road network;
II. using a classifier to classify the location data to a cluster for generating classified location data; and
III. determining a driving path of the vehicle on the road network based on the classified location data by:
determining possible driving paths on the road network between at least two data points of the location data, and
applying a policy of the cluster to select the driving path from the possible driving paths;
wherein:
the classifier is a trained machine learning model that is trained on known driving data labelled with cluster labels of clusters;
the known driving data comprises known location data and known road segment features;
each of the clusters comprises a set of the known driving data and a reward function that are determined by:
training policies for the clusters using an inverse reinforcement learning (IRL) model, wherein the IRL model comprises:
the known road segment features as inputs to the reward function for each of the clusters, and
known driving paths corresponding to the known driving location as expert behavior; and
the clusters and each set of the known driving data corresponding to the clusters are labelled with the cluster labels.
